(19) United States
(12) Patent Application Publication
(10) Pub. No.: US 2014/0253482 A1
(43) Pub. Date: Sep. 11, 2014

(54) INFORMATION PROCESSING APPARATUS, INFORMATION PROCESSING METHOD, AND PROGRAM

(71) Applicant: SONY CORPORATION, Tokyo (JP)

(72) Inventors: MASATAKA TOYOURA, Tokyo (JP); HIROMITSU FUJII, Tokyo (JP); KENTARO IDA, Tokyo (JP)

(73) Assignee: SONY CORPORATION, Tokyo (JP)

(21) Appl. No.: 14/196,737

(22) Filed: Mar. 4, 2014

(30) Foreign Application Priority Data
Mar. 11, 2013 (JP) 2013-047746

(51) Int. Cl. G06F 3/041

(52) U.S. Cl. CPC G06F 3/041
USPC 345/173

(57) ABSTRACT

An information processing apparatus includes an input unit and a control unit. The input unit is configured to be capable of inputting, as operation information for detecting an operation on an operation surface of an operation body, first operation information for detecting an up-operation from the operation surface, the first operation information including information on an up-position as information on a position at which the up-operation is performed. The control unit is configured to determine whether or not the input first operation information is valid based on a change amount in a movement direction on the operation surface of the operation body at a position with the up-position being a reference.

### CROSS REFERENCE TO RELATED APPLICATION(S)

This application claims the benefit of Japanese Priority Patent Application JP 2013-047746 filed Mar. 11, 2013, the entire contents of which are incorporated herein by reference.

### BACKGROUND

The present disclosure relates to an information processing apparatus, an information processing method, and a program that are capable of performing processing according to an operation via a touch panel or the like.

As described in Japanese Patent Application Laid-open No. 2012-113645 (hereinafter, referred to as Patent Document 1), electronic apparatuses each including a touch sensor such as a touch panel and a touch switch are prevailed. For example, in a cellular phone terminal such as a smart phone and various personal digital assistants (PDAs) such as a tablet terminal, the touch sensors are widely used. Patent Document 1 describes a technique for reducing a possibility that processing not intended by an operator is performed when the operator operates the touch sensor.

### SUMMARY

It is considered that the electronic apparatuses each including the touch panel and the like are further prevailed in the future, and the technique for improving the operability as described in Patent Document 1 is desirable also in the future. Thus, it is desirable to provide high operability to a user who performs a touch operation.

In the above-mentioned circumstances, it is desirable to provide an information processing apparatus, an information processing method, and a program that are capable of improving operability relating to a touch operation on an operation surface.

According to an embodiment of the present disclosure, there is provided an information processing apparatus including an input unit and a control unit.

The input unit is configured to be capable of inputting, as operation information for detecting an operation on an operation surface of an operation body, first operation information for detecting an up-operation from the operation surface, the first operation information including information on an up-position as information on a position at which the up-operation is performed.

The control unit is configured to determine whether or not the input first operation information is valid based on a change amount in a movement direction on the operation surface of the operation body at a position with the up-position being a reference.

In this information processing apparatus, as the operation information for detecting an operation on the operation surface of the operation body, the first operation information for detecting the up-operation from the operation surface is inputted. Then, based on the change amount in the movement direction of the operation body at the position with the up-position being a reference, whether or not the input first operation information is valid is determined. With this, it is possible to prevent erroneous processing due to error detection of the up-operation, and to improve the operability relating to the touch operation on the operation surface.

The control unit may be configured to determine that the input first operation information is not valid when the change amount in the movement direction on the operation surface of the operation body is smaller than a predetermined value.

When the change amount in the movement direction is smaller than the predetermined value, there is a high possibility that the up-operation is actually performed. Thus, by such a setting, it is possible to prevent error processing due to error detection of the up-operation.

The input unit may be configured to be capable of inputting second operation information for detecting a down-operation on the operation surface, the second operation information including information on a down-position as information on a position at which the down-operation is performed. In this case, the control unit may be configured to perform the determination when the second operation information for detecting the down-operation is input next to input of the first operation information.

In this manner, when the second operation information is input next to the input of the first operation information, the validity of the previously input first operation information may be determined. With this, it is possible to improve the operability relating to the touch operation.

The control unit may be configured to define, based on a displacement amount between a reference direction calculated with the up-position being a reference and a calculation direction calculated as a direction extending from the up-position to the down-position next to the up-position, the change amount in the movement direction on the operation surface of the operation body.

In this manner, the change amount in the movement direction may be defined based on the displacement amount between the reference direction with the up-position being a reference and the calculation direction calculated from the up-position and the down-position next to the up-position. With this, it becomes possible to determine the change amount in the movement direction by a simple calculation.

The control unit may be configured to perform the determination when the input of the second operation information is performed within a predetermined period of time from input of the first operation information.

In this manner, when the predetermined condition is satisfied, whether or not the first operation information is valid may be determined. With this, it becomes possible to perform various touch operations with excellent operability.

The control unit may be configured to perform the determination when sensitivity of a touch operation including at least the up-operation and the down-operation is smaller than a predetermined value.

In this manner, when the predetermined condition is satisfied, whether or not the first operation information is valid may be determined. With this, it becomes possible to perform various touch operations with excellent operability.

The control unit may be configured to perform the determination when a distance between the up-position and the down-position is smaller than a predetermined value.

In this manner, when the predetermined condition is satisfied, whether or not the first operation information is valid may be performed. With this, it becomes possible to perform various touch operations with excellent operability.

According to another embodiment of the present disclosure, there is provided an information processing method that is caused by a computer, the method including inputting, as operation information for detecting an operation on an operation surface of an operation body, first operation information for detecting an up-operation from the operation surface, the first operation information including information on an up-position as information on a position at which the up-operation is performed.

Whether or not the input first operation information is valid is determined based on a change amount in a movement direction on the operation surface of the operation body at a position with the up-position being a reference.

According to still another embodiment of the present disclosure, there is provided a program that causes a computer to execute the steps of:

inputting, as operation information for detecting an operation on an operation surface of an operation body, first operation information for detecting an up-operation from the operation surface, the first operation information including information on an up-position as information on a position at which the up-operation is performed; and
determining whether or not the input first operation information is valid based on a change amount in a movement direction on the operation surface of the operation body at a position with the up-position being a reference.

As described above, according to the embodiments of the present disclosure, it is possible to improve operability relating to a touch operation on an operation surface.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic block diagram showing a hardware configuration example of an information processing apparatus according to an embodiment of the present disclosure;

FIG. 2 is a schematic block diagram showing a software configuration example for performing an information processing method according to this embodiment;

FIG. 3 is a view for explaining an outline of an operation of a tablet terminal according to this embodiment;

FIGS. 4A and 4B are views for explaining an outline of an operation of the tablet terminal according to this embodiment;

FIG. 5 is a view for explaining generation of a discontinuous portion in detail;

FIG. 6 is a view for explaining generation of a discontinuous portion in detail;

FIG. 7 is a flowchart showing an example of processing by the tablet terminal in detail;

FIG. 8 is a graph for explaining a determination based on sensitivity of the touch operation;

FIG. 9 is a view for explaining a determination based on a temporal interval of the touch operation;

FIG. 10 is a view for explaining a determination based on an angle between a reference direction and a calculation direction;

FIG. 11 is a view for explaining a determination based on a distance between an up-position and a down-position;

FIG. 12 is a table for explaining adjustment of each parameter used for determining validity of an up-event;

FIG. 13 is a state transition view showing an operation example of a tablet terminal 100 according to this embodiment;

FIG. 14 is a view showing an example of an event defined in this embodiment;

FIG. 15 is a view showing an example in a state defined in this embodiment;

FIG. 16 is a block diagram showing an implementation example of a validity determination module according to an embodiment of the present disclosure;

FIG. 17 is a view showing an example in which a parameter for determining the validity of the up-event is dynamically changed depending on a situation;

FIG. 18 is a view for explaining an outline of a strain correction technique related to the present disclosure;

FIG. 19 is a view for explaining an outline of a strain correction technique related to the present disclosure;

FIG. 20 is a view for explaining an outline of a strain correction technique related to the present disclosure;

FIG. 21 is a view for explaining details of the strain correction technique;

FIG. 22 is a view for explaining details of the strain correction technique;

FIG. 23 is a view for explaining details of the strain correction technique;

FIG. 24 is a table for explaining tuning of a parameter used for a strain correction filter;

FIG. 25 is a view for observing effects of the strain correction filter in an entire operation surface; and

FIG. 26 is a view for observing the effects of the strain correction filter in the entire operation surface.

### DETAILED DESCRIPTION OF EMBODIMENTS

Hereinafter, embodiments of the present disclosure will be described with reference to the drawings.

[Configuration of Information Processing Apparatus]

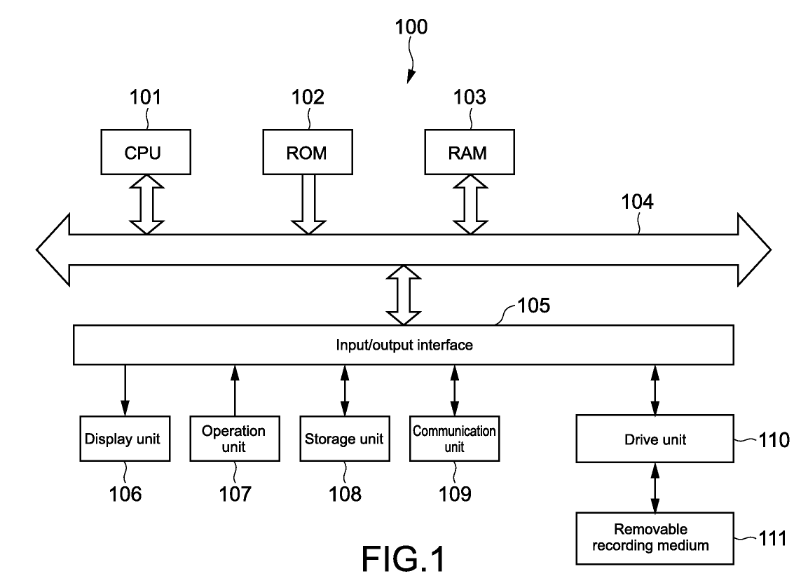

FIG. 1 is a schematic block diagram showing a hardware configuration example of an information processing apparatus according to an embodiment of the present disclosure. Various computers capable of executing information processing according to a touch operation input into an input device such as a touch panel are used as the information processing apparatus. For example, a portable terminal such as a smart phone including a touch panel and the like is used or various PDAs are used. Otherwise, a personal computer (PC) or the like connected to the above-mentioned input device may be used. In this embodiment, a tablet terminal 100 is used as the information processing apparatus.

The tablet terminal 100 includes a central processing unit (CPU) 101, a read only memory (ROM) 102, a random access memory (RAM) 103, an input/output interface 105, and a bus 104 that connects them to one another.

A display unit 106, an operation unit 107, a storage unit 108, a communication unit 109, a drive unit 110, and the like are connected to the input/output interface 105.

The display unit 206 is a display device that uses, for example, liquid crystal, electro-luminescence (EL), or a cathode ray tube (CRT).

The operation unit 107 is formed of a device including an operation surface on which a user can input a touch operation. In this embodiment, a touch panel (hereinafter, referred to as touch panel 107) is used as the operation unit 107. Thus, the operation unit 107 and the display unit 106 are integrally configured. The configuration of the touch panel 107 is not limited. For example, the touch panel 107 of various types such as a capacitive type, a resistive film type, a surface acoustic wave type, and an infrared type may be used. Otherwise, another touch sensor such as a touch pad may be used. Further, other operation apparatuses such as a controller, a pointing device, and a keyboard may be used together with the touch panel 107 and the like.

The storage unit 108 is a non-volatile storage device. The storage unit 108 is, for example, a hard disk drive (HDD), a flash memory, or another solid-state memory.

The drive unit 110 is, for example, a device capable of driving a removable recording medium 111 such as an optical recording medium, a floppy (registered trademark) disk, a magnetic recording tape, and a flash memory. In contrast, the storage unit 108 is often used as a device installed into the tablet terminal 100 in advance, which mainly drives a non-removable recording medium.

The communication unit 109 is a modem, a router, or another communication apparatus for communicating with another device, the modem, the router, or the other communication apparatus being connectable to a LAN, a wide area network (WAN), or the like. The communication unit 109 may perform a wired or wireless communication. The communication unit 109 is often used separately from the tablet terminal 100.

Information processing by the tablet terminal 100 having the hardware configuration as described above is realized by cooperation of software stored in the storage unit 108, the ROM 102, or the like and a hardware resource of the tablet terminal 100. Specifically, the information processing is realized by the CPU 101 loading a program configuring software that is stored in the storage unit 108, the ROM 102, or the like into the RAM 103 and executing the loaded program.

The programs are installed into the tablet terminal 100 via, for example, the recording medium 111. Alternatively, the programs may be installed into the tablet terminal 100 via a global network or the like. Further, the programs to be executed by the tablet terminal 100 may be programs chronologically performed or programs processed in parallel or at a necessary timing, for example, when calling is performed.

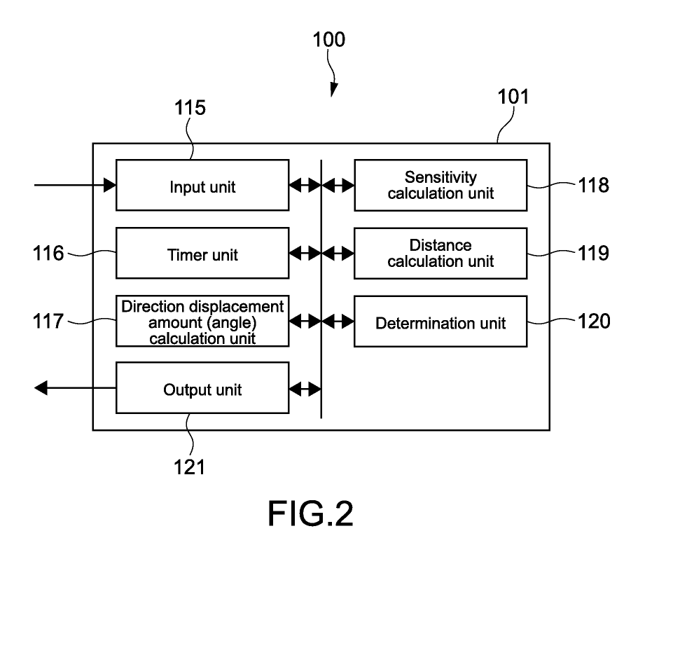

FIG. 2 is a schematic block diagram showing a software configuration example for executing an information processing method according to this embodiment. In this embodiment, the information processing according to the present disclosure is performed by an input unit 115, a timer unit 116, a direction displacement amount (angle) calculation unit 117, a sensitivity calculation unit 118, a distance calculation unit 119, a determination unit 120, and an output unit 121. Those software blocks are realized by the CPU 101 of the tablet terminal 100 executing a predetermined program. That is, in this embodiment, the CPU 101 functions as a control unit. Note that dedicated hardware may be appropriately used for realizing each block.

The input unit 115 inputs operation information for detecting a touch operation on the operation surface of the touch panel 107 by the operation body (operation element). Examples of the touch operation on the operation surface include a down-operation of bringing the operation body such as a finger into contact with the operation surface and an up-operation of releasing the contact with the operation surface. The examples of the touch operation on the operation surface further include a move operation (drag operation) of moving the operation body while continuing the down-operation and a flick operation of releasing the contact while instantly moving the operation body in a predetermined direction. In addition, a multi-touch operation such as a pinch-in/out operation of bringing two operation bodies into contact with the operation surface and changing a distance therebetween may also be input. Additionally, various touch operations are input.

In this embodiment, operation information for detecting a touch operation is generated by the touch panel 107 and output to the input unit 115. As the operation information, first operation information for detecting an up-operation from the operation surface and second operation information for detecting a down-operation to the operation surface are output. The first operation information includes position information on the up-position being a position at which the contact of the operation body with the operation surface is released. Further, the second operation information includes position information on the down-position being a position at which the operation body is brought into contact with the operation surface. The position information is, typically, coordinate information based on an xy-coordinate system set on the operation surface.

As other operation information, operation information for detecting the move operation is generated. In this embodiment, the contact with the operation surface is detected at a predetermined sampling rate. When the down-operation is continuously calculated with the down-position being changed, it is detected as the move operation. Thus, the second operation information continuously generated with the down-position being changed corresponds to the operation information for detecting the move operation.

The generated operation information is output to the CPU 101 via the input/output interface 105. Thus, the input/output interface 105 may function as part of the input unit 115. On the other hand, information or a signal relating to the contact with the operation surface is output from the operation unit 107. Then, the CPU 101 may determine what touch operation has been input into the operation surface based on the information or the like. In this case, the operation information for detecting the touch operation is generated by the CPU 101.

The input unit 115 is configured within the CPU 101.

The timer unit 116 determines a time interval from input of the first operation information according to the up-operation to input of the second operation information according to the down-operation next to the up-operation. In this embodiment, a timer in which a fire timing is appropriately set is used. However, a method and an algorithm for determining the interval between the inputs of the first operation information and the second operation information are not limited.

Depending on the input of the first operation information according to the up-operation and the input of the second operation information according to the down-operation next to the up-operation, the direction displacement amount calculation unit 117 calculates a displacement amount between a reference direction calculated with the up-position being a reference and a calculation direction calculated as a direction extending from the up-position to the down-position. In this embodiment, the above-mentioned displacement amount is calculated based on the angle between the reference direction and the calculation direction. Alternatively, the displacement amount between the reference direction and the calculation direction may be calculated based on a curvature or the like.

The sensitivity calculation unit 118 calculates sensitivity of the various touch operations including at least the up-operation and the down-operation. For example, a case where the finger is used as the operation body that inputs the touch operation into the operation surface and a case where a stylus pen (touch pen) is used are compared. In this case, the sensitivity of the touch operation varies depending on a difference of properties such as composition (material) and thickness (contact area) between the finger and the stylus pen. Typically, in the case of using the finger, the sensitivity of the touch operation is higher. In the case of using the stylus pen, the sensitivity is lower. Moreover, the sensitivity varies due to an operation method and the like. Note that the operation body to be used is not limited to the finger and the stylus pen.

The distance calculation unit 119 calculates a distance between the up-position and the down-position based on the first operation information and the next input second operation information. In this embodiment, the distance between two points is calculated based on coordinate information of the two points. Another method may be used to calculate the distance between the two points.

Based on the displacement amount between the reference direction and the calculation direction calculated by the direction displacement calculation unit 117, the determination unit 120 determines whether or not the input first operation information is valid. Specifically, if the displacement between the reference direction and the calculation direction (angle) is smaller than the predetermined value, it is determined that the first operation information is not valid. Further, in this embodiment, the determination unit 120 determines, based on a calculation result of the timer unit 116, whether or not the input of the second operation information has been performed within the predetermined period of time from the input of the first operation information just before the input of the second operation information. If it is determined that the input of the second operation information has been performed within the predetermined period of time, a determination of the validity of the first operation information is performed.

Further, in this embodiment, the determination unit 120 determines whether or not the sensitivity of the touch operation that is calculated by the sensitivity calculation unit 118 is smaller than a predetermined value. If the sensitivity of the touch operation is smaller than the predetermined value, a determination of the validity of the first operation information is performed. In addition, in this embodiment, the determination unit 120 determines whether or not the distance between the two points that is calculated by the distance calculation unit 119 is smaller than the predetermined value. If the distance between the two points is smaller than the predetermined value, a determination of the validity of the first operation information is performed. The result of the determination performed by the determination unit 120 is output by the output unit 121. The output unit 121 is realized by the CPU 101 and the input/output interface 105.

[Operation of Information Processing Apparatus]

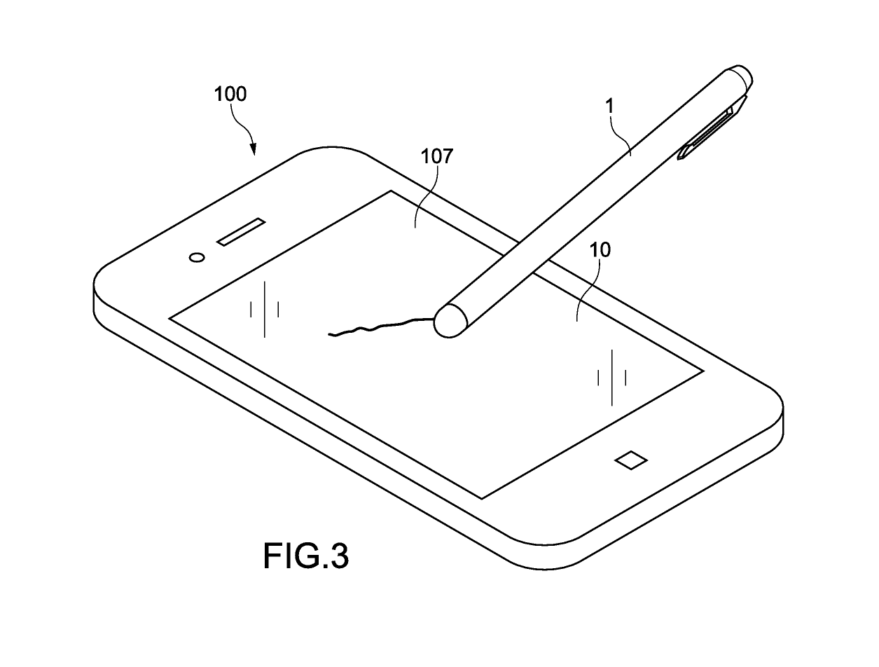

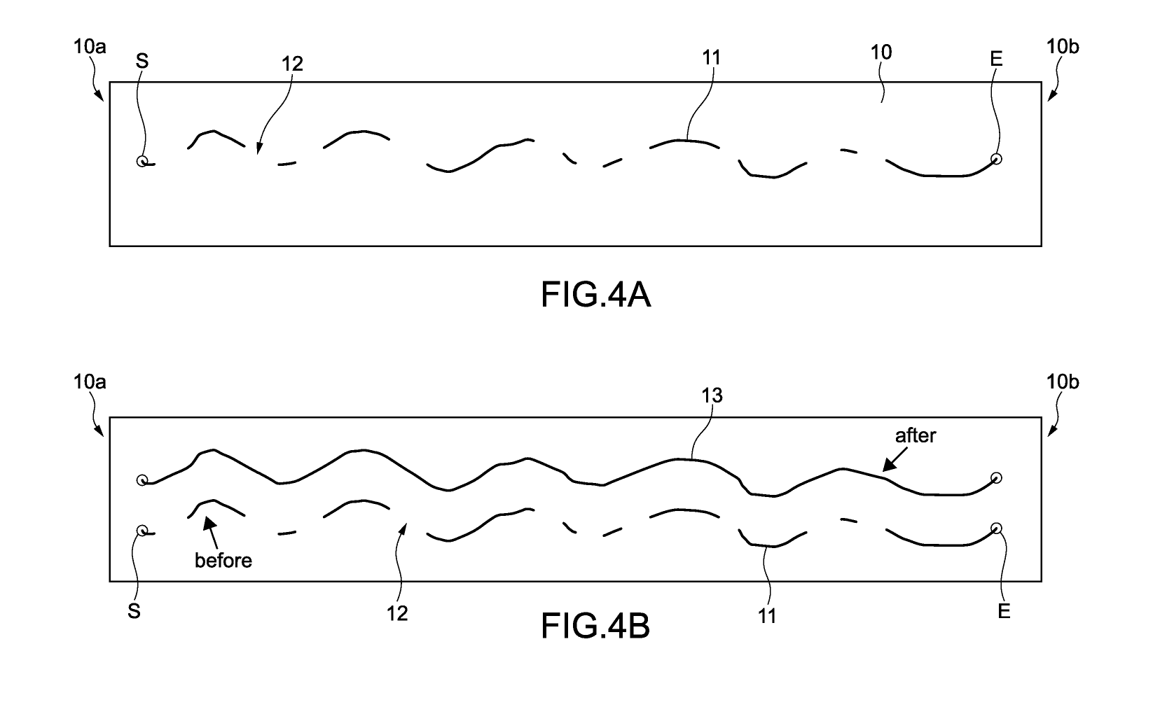

An operation of the tablet terminal 100 of the information processing apparatus according to this embodiment will be described. FIGS. 3, 4A, and 4B are views for explaining an outline of the operation. As shown in FIG. 3, a case where the touch operation is input into an operation surface 10 of the touch panel 107 with a touch pen 1 is assumed. The input of the touch operation is used in various applications. For example, in selecting or moving a predetermined icon or drawing a picture or a character, the touch operation with the touch pen 1 is input.

The sensitivity of the touch operation can become low, for example, because the touch pen 1 has a very thin tip end. In such a case, as shown in FIG. 4A, when a move operation is input from an end portion 10a to an end portion 10b of the operation surface 10, even if the touch pen 1 is not separated from the operation surface 10, the move operation can be discontinuous. As a result, between a start point S and an end point E of a line 11 to be drawn, discontinuous portions 12 in which drawing is discontinuous are generated. In this case, the operation of the icon or the like, drawing of the picture, or the like is significantly influenced. With the tablet terminal 100 according to this embodiment, as shown in FIG. 4B, it becomes possible to draw a corrected line 13 in which the discontinuous portions 12 are corrected. That is, it becomes possible to prevent the discontinuous portions 12 from being generated. Thus, it becomes possible to improve the operability relating to the touch operation on the operation surface 10.

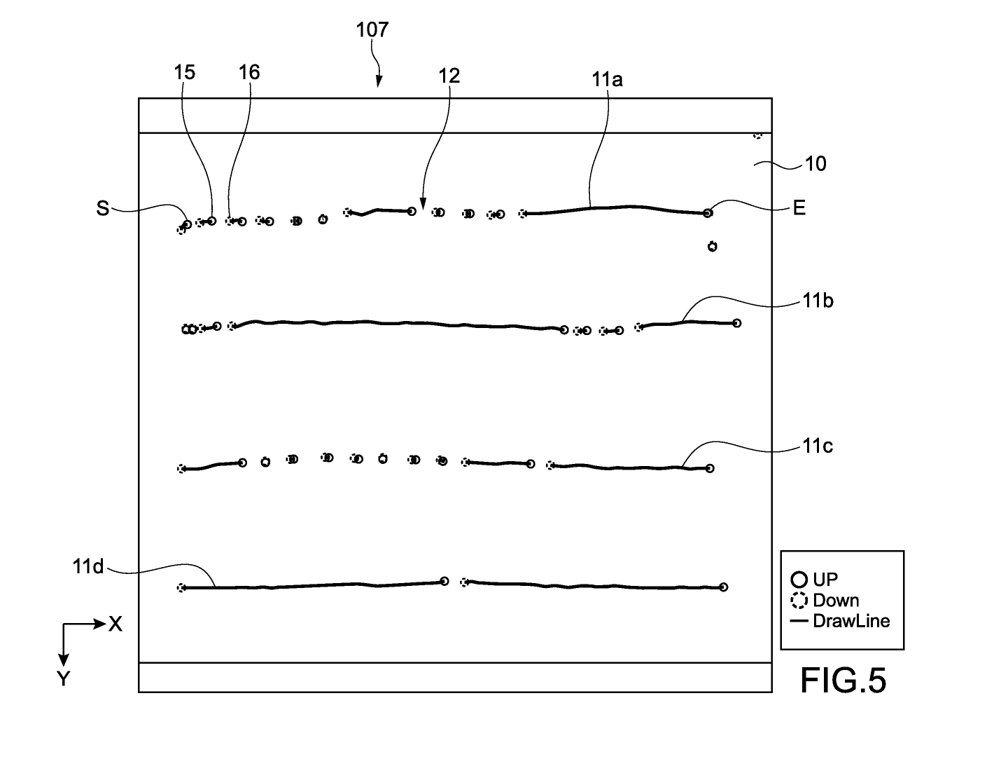

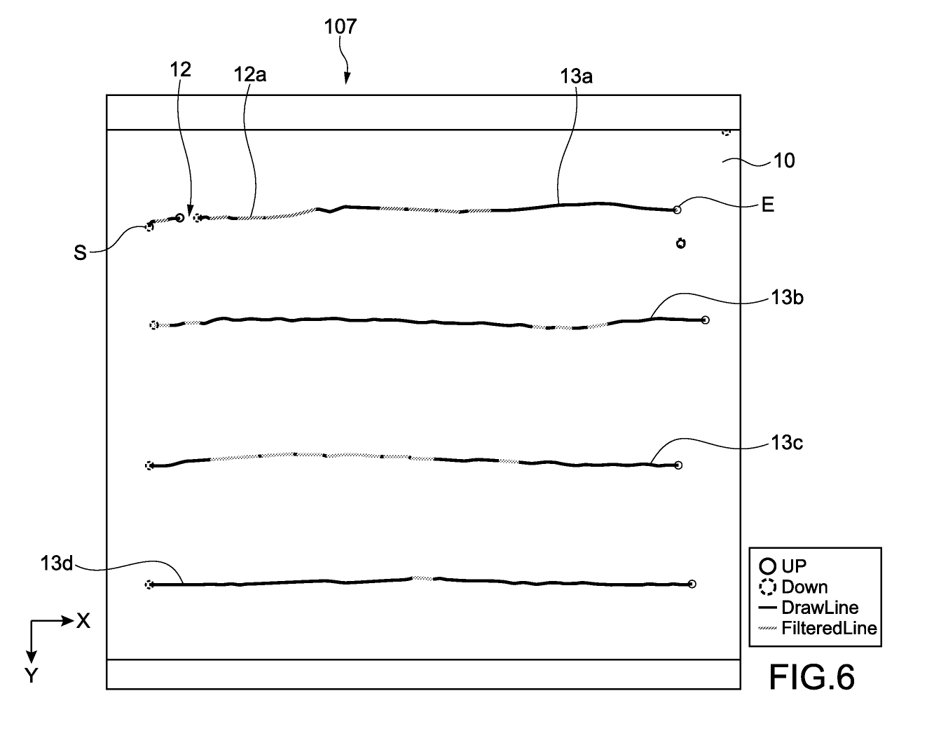

FIGS. 5 and 6 are views for explaining the generation of the discontinuous portions 12 in detail. In FIGS. 5 and 6, a move operation is input from a start point S on a left-hand side to an end point E on a right-hand side of the operation surface 10. Four move operations are input while changing the positions in upper and lower directions of the operation surface 10. When the touch pen 1 is separated from the operation surface 10, an up-event 15 (solid-line circle) is detected as the first operation information for detecting the up-operation. Further, when the touch pen 1 is brought into contact with the operation surface 10, a down-event 16 (broken-line circle) is detected as the second operation information for detecting the down-operation. While the move operation is being input, the down-events are continuously detected with the down-position being changed at a predetermined sampling rate (down-events of move operation are not shown in the figure).

For example, in the case where the sensitivity of the touch operation is low, the up-events 15 may be erroneously detected during input of the move operation. In such a case, as indicated by four lines 11a to 11d of FIG. 5, the line 11 is not drawn and the discontinuous portion 12 is generated by the time when the next down-event 16 is detected. In the line 11a of FIG. 5, error detection of the up-event 15 repeatedly occurs just after the start of drawing and the error detection occurs also in the middle. Regarding the line 11b, the error detection of the up-event 15 occurs in a first half and a second half. Regarding the line 11c, the error detection of the up-event 15 repeatedly occurs in the almost entire first half. Regarding the line 11d, the error detection of the up-event 15 occurs one time in a middle part thereof. In any cases, the discontinuous portions 12 are present between the erroneously detected up-events 15 and the next down-events 16.

In this embodiment, by the processing shown in the following, whether or not the generated up-event 15 is valid is determined. As a result, if it is determined that the up-event 15 is valid, that up-event 15 is issued as it is. Then, processing based on the up-event 15 is performed. For example, processing of dropping an icon being dragged is performed or stop of drawing of a line or a character is performed. On the other hand, if it is determined that the up-event 15 is not valid, the up-event is discarded. Accordingly, as shown in FIG. 6, the erroneously detected up-event 15 is discarded and corrected lines 13a to 13d in which the discontinuous portions 12 are corrected are drawn. In the case where the touch operation is a drag operation of an icon or the like, that operation is correctly continued without interruption.

A discontinuous portion 12 is generated in the corrected line 13a of FIG. 6, which is an error. Regarding other portions and other lines 13b to 13d, the generation of the discontinuous portions 12 is sufficiently suppressed. That is, it can be seen that high operability relating to the touch operation is exerted. Further, in FIG. 6, the line 12a drawn on the discontinuous portions 12 is shown as Filtered Line. This means that the processing of determining the validity of the up-event 15 is set as a filter and the line 12a is drawn as a result of the filter. Although will be described later, whether or not this filter is set is dynamically switched in this embodiment.

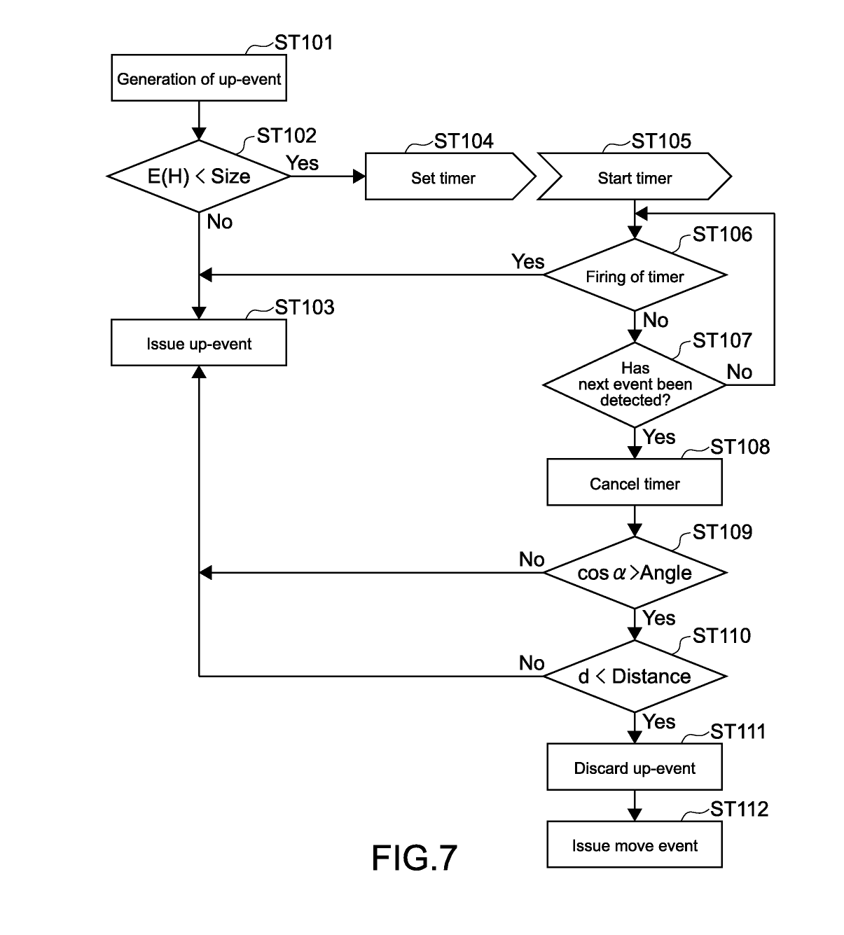

FIG. 7 is a flowchart showing an example of processing by the tablet terminal 100 in detail. When the up-event 15 is generated and input into the input unit 115 (Step 101), whether or not the sensitivity of the touch operation is smaller than a predetermined value is determined (Step 102).

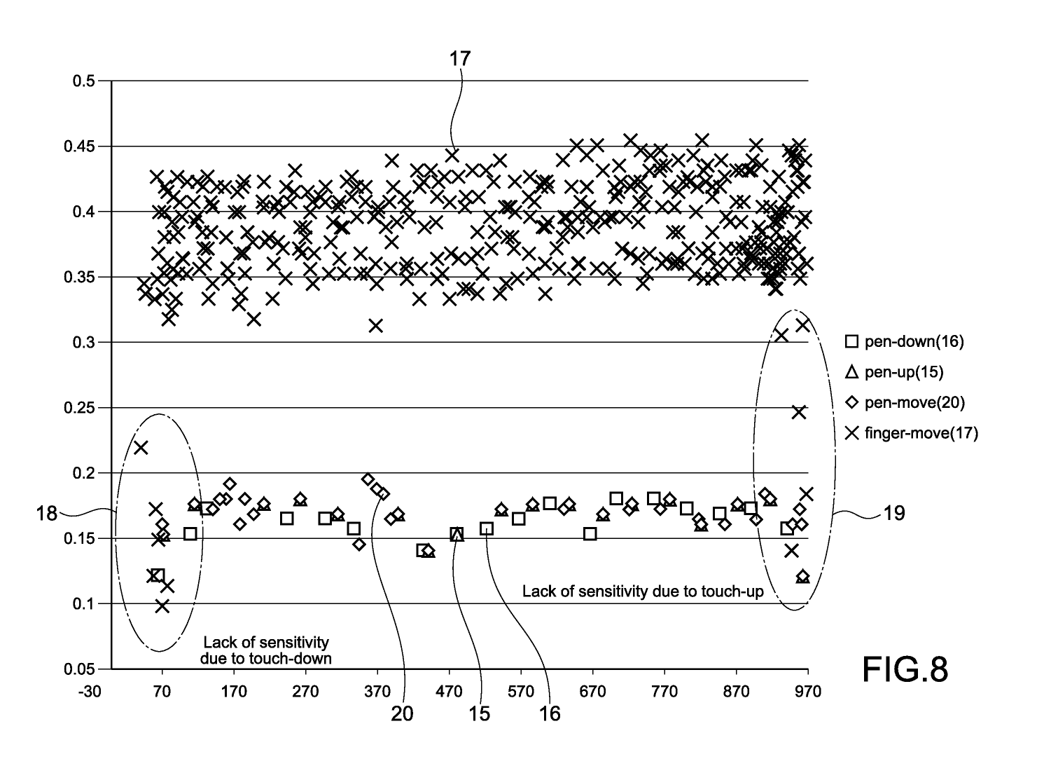

FIG. 8 is a graph for explaining a determination based on the sensitivity of the touch operation. The graph shows a sensitivity value when a plurality of move operations are input in left- and right hand directions (corresponding to x-axis direction in FIG. 5 and the like) of the operation surface 10 with each of the finger and the touch pen. The horizontal axis of the graph indicates a time (msec) and the vertical axis of the graph indicates a sensitivity value. A calculation method for the sensitivity value is not limited. For example, a size of an area in which a contact is detected or a contact strength is calculated as the sensitivity value. For example, a value of MotionEvent.getSize on Android that provides basic software (OS: operating system) functions may be used.

Symbols x on the graph indicate move events 17 (continuous down-events) detected with respect to the move operation with the finger. Sensitivity values of a portion 18 surrounded by an alternate long and short dash line on a lower left-hand side of the graph are sensitivity values when a contact with the operation surface 10 is performed. At the start of the move operation, the finger is pressed against the start point S of the operation surface 10. At a moment when the finger is brought into contact with the operation surface 10, the sensitivity value is small because the contact area is small. As the contact area becomes larger, the sensitivity value becomes larger. Sensitivity values of the portion 19 surrounded by an alternate long and short dash line on a right-hand side of the graph are sensitivity values when the finger is separated from the operation surface 10. At the end point E at which the move operation ends, as the finger becomes separated, the contact area becomes smaller. Along with this, the sensitivity value becomes smaller. In a time band between the start point S and the end point E, the move events 17 are detected with stable sensitivity values.

In comparison with the finger, the sensitivity values of the move operation with the touch pen are generally low irrespective of the start point S and the end point E. The erroneously detected up-event 15 and the next down-event 16 are generated. Further, the graph shows also move events 20 with the touch pen. For example, with a predetermined sensitivity value being a reference, if the sensitivity value larger than that value is detected, it is determined as a down-event. If the sensitivity value smaller than that value is detected, it is determined as an up-event. As shown in FIG. 8, in the move operation with the touch pen in which the sensitivity value is generally low, the error detection of the up-event 15 occurs many times although depending on the trajectory thereof.

In this embodiment, the sensitivity of the touch operation is expressed by E(H) according to the following formula.

$$E ( H ) = \frac{{\sum }_{n = 0}^{n = NUM - 1} {S}_{n}}{NUM} 〈 Size \qquad [ Math . 1 ]$$

Note that parameters in the expression are as follows.

Sₙ: History of sensitivity values until up-event is detected after start of touching

NUM: Number of histories

Size: Threshold

Specifically, an average value E(H) of sensitivity values of the touch events (including up-events 15, down-events 16, and move events 20) detected from the start point S to generation of the up-event 15 is calculated as the sensitivity of the touch operation. Then, whether or not that value is smaller than the threshold Size is determined. Note that the history Sₙ of the sensitivity values is stored in the storage unit 108. If it is determined that the average value E(H) is larger than the threshold Size (No in Step 102), the up-event 15 is issued as it is (Step 103). That is, if the average value E(H) is larger than the threshold Size, it can be determined that the touch operation is input with the operation body having high sensitivity such as the finger. In such a case, the possibility that the error detection of the up-event 15 occurs is low, and hence processing of determining the validity of the up-event 15 is not performed.

If it is determined that the average value E(H) is smaller than the threshold Size (Yes in Step 102), it is determined that the touch operation is input with the operation body having low sensitivity such as the touch pen. In such a case, there is a possibility that the error detection of the up-event 15 occurs, and hence a determination of the validity of the up-event 15 is performed. Therefore, in this embodiment, a timer is set (Step 104). Thus, in this embodiment, whether or not to set the processing of determining the up-event 15 as the filter is dynamically switched according to the determination of the sensitivity of the touch operation in Step 102. In other words, the switching between a mode in which whether or not the up-event 15 is valid is determined and a mode in which whether or not the up-event 15 is valid is not determined is dynamically performed.

When the validity of the up-event 15 is determined, the possibility that the up-event 15, which is valid, is discarded as being invalid in the case of the flick operation, the multi-touch operation, or the like cannot be denied. Therefore, in the case of the operation body having a high sensitivity value such as the finger, setting not to perform a determination of the validity is dynamically performed. In this embodiment, a state in which there is a high possibility that the error detection occurs due to low sensitivity and a state in which the touch operation can be stably and correctly detected due to high sensitivity are determined, and whether or not to perform a determination of the validity is switched. With this, the operability of the touch operation can be made sufficiently high.

Note that a method of calculating the sensitivity of the touch operation is not limited. For example, in the above-mentioned formula E(H), the number of histories NUM may be appropriately set. A predetermined number of touch events just before the up-event 15 may be set as the number of histories NUM. Alternatively, if the determination of the sensitivity can be correctly performed, the determination may be performed based on a sensitivity value of a touch event at a single point. If the number of histories NUM is set to a sufficiently large number, an appropriate average value E(H), which is not influenced by the sensitivity value at the start point S and the end point E in the portion 18 on the lower left-hand side and the portion 19 on the right-hand side of the graph, can be calculated.

The number of histories NUM and the threshold Size may be appropriately set based on the properties of the touch panel and the type of the performed touch operation. If the operation with the operation body having a high sensitivity value such as the finger can be determined, arbitrary setting may be employed.

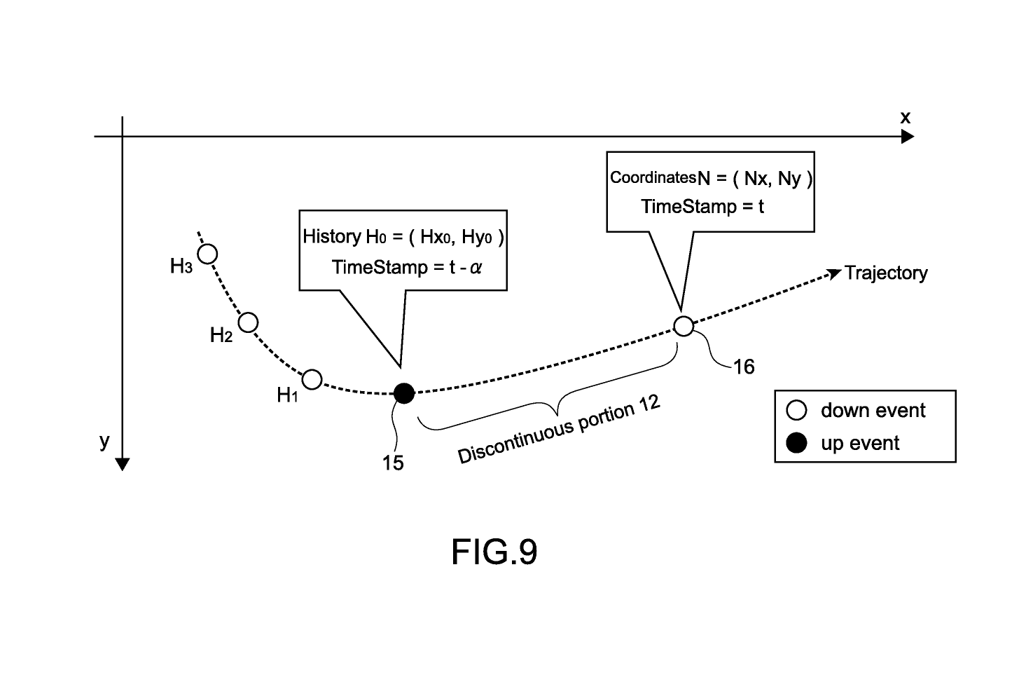

In Steps 104 to 108, a determination based on the time interval of the touch operation is performed. FIG. 9 is a view for explaining a determination based on the time interval of the touch operation. For example, if the up-event 15 shown in FIG. 9 is erroneously detected in the move operation, the next down-event 16 can be expected immediately after the up-event 15. Thus, the issue of the up-event 15 is delayed by the timer and the next down-event 16 is waited for. If the next down-event 16 is detected within the predetermined period of time, the previously detected up-event 15 is discarded. That is, if a of a time stamp (t-a) of the up-event 15 shown in FIG. 9 is smaller than a period of time until the set timer fires, the up-event 15 is discarded. With this, it is possible to prevent the discontinuous portion 12 from being generated. Note that a time duration set as a threshold, that is, a time duration set until the timer fires can be appropriately set. This time is directly linked to a delay time until an appropriate up-event 15 is issued, and hence only needs to be appropriately set by tuning depending on the environment and the device.

As shown in FIG. 7, the timer is started (Step 105), and whether or not the timer fires is determined (Step 106). If the timer fires before the next down-event 16 is detected (Yes in Step 106), the up-event 15 is issued (Step 103). That is, it is determined that the up-event 15 is not erroneously detected. With this, the filter is disabled.

If it is determined that the timer does not fire (No in Step 106), whether or not the next down-event 16 is detected is determined (Step 107). If the next down-event 16 is not detected (No in Step 107), the processing returns to Step 106. If the next down-event 16 is detected (Yes in Step 107), the timer is cancelled (Step 108). That is, assuming that there is a possibility that the up-event 15 is erroneously detected, a determination based on the displacement (angle) in a next direction is performed.

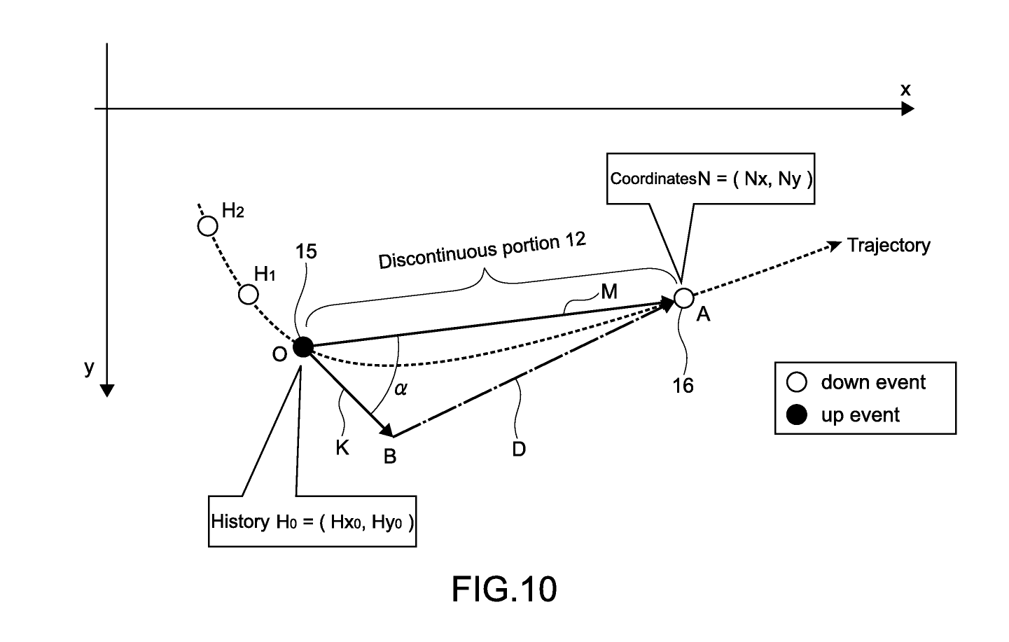

FIG. 10 is a view for explaining a determination based on the displacement between the reference direction and the calculation direction (angle). A reference point B is calculated by averaging movement amounts from touch event histories H (H₁, H₂, . . . ) in an interval before the up-event 15 is detected. For example, as shown in the following formula, an average of the movement amounts in each interval from the start point S to an up-point O being the up-position of the up-event 15 is calculated.

$$Bx = \frac{{\sum }_{n = 0}^{n = NUM - 1} {Hx}_{n} - {Hx}_{n + 1}}{NUM - 1} , \\ By = \frac{{\sum }_{n = 0}^{n = NUM - 1} {Hy}_{n} - {Hy}_{n + 1}}{NUM - 1} \qquad [ Math . 2 ]$$

(Bx, By) denotes x- and y-coordinates of the reference point B with the up-point O being a reference. A direction (vector K) from the up-point O to the reference point B becomes the reference direction. The calculation method for the reference direction is not limited. For example, the reference direction may be calculated by calculating an average movement amount in a predetermined number of intervals before the up-point O. Alternatively, a direction linking between the up-point O and a down-point H₁ just before the up-point O may be calculated as the reference direction. Otherwise, a direction in which the move operation will move if the move operation is continued even after the up-point O may be calculated by an arbitrary method.

Further, a direction (vector M) extending from the up-point O to a down-point A that is the down-position is calculated as the calculation direction. Then, an angle α (∠AOB) between the vector K and the vector M is determined as the displacement between the reference direction and the calculation direction. If the angle α is smaller than the predetermined value, the up-event 15 is discarded as being erroneously detected in the move operation. If the angle α is larger than the predetermined value, it is determined that it jumps and moves to a different position on the operation surface, and the up-event 15 is issued as it is.

Regarding the determination of the angle α, in this embodiment, cos α is calculated from coordinates of the up-point O, the reference point B, and the down-point A. Whether or not this cos α is larger than a threshold Angle is determined. Assuming that a determination range of α is from 0° to 180°, cos α is a decreasing function in that range. Thus, if cos α is smaller than the threshold Angle, the angle α is larger than a predetermined threshold. If cos α is larger than the threshold Angle, the angle α is smaller than the predetermined threshold.

For the calculation of cos α, the magnitude of a line segment OA (magnitude of vector M), the magnitude of a line segment OB (magnitude of vector K), and the magnitude of a line segment AB (magnitude of vector D) are first calculated according to the following formula.

OA=\sqrt{(Nx−Hx₀)²+(Ny−Hy₀)₂}

OB=\sqrt{(Bx−Hx₀)²+(By−Hy₀)²}

AB=\sqrt{(Bx−Nx)²+(By−Ny)²} [Math. 3]

As shown in the following formula, cos α is calculated using the law of cosines and compared with the threshold Angle.

$${AB}^{2} = {OA}^{2} + {OB}^{2} - 2 OA * OB * cos α \\ cos α = \frac{{OA}^{2} + {OB}^{2} - {AB}^{2}}{2 OA * OB} 〉 Angle \qquad [ Math . 4 ]$$

If this cos α is smaller than the threshold Angle (angle α is larger), it is determined as not being continuous points and the filter is disabled. That is, it is determined as No in Step 109 of FIG. 7, and the up-event 15 is issued. If cos α is larger than the threshold Angle (angle α is smaller), in order to determine the validity of the up-event 15, the following determination based on the distance between the two points is performed. The above-mentioned determination based on the angle is effective against a problem of excessive connection of points confusing a lack of sensitivity with handwriting particularly when a character is written with a touch pen, for example.

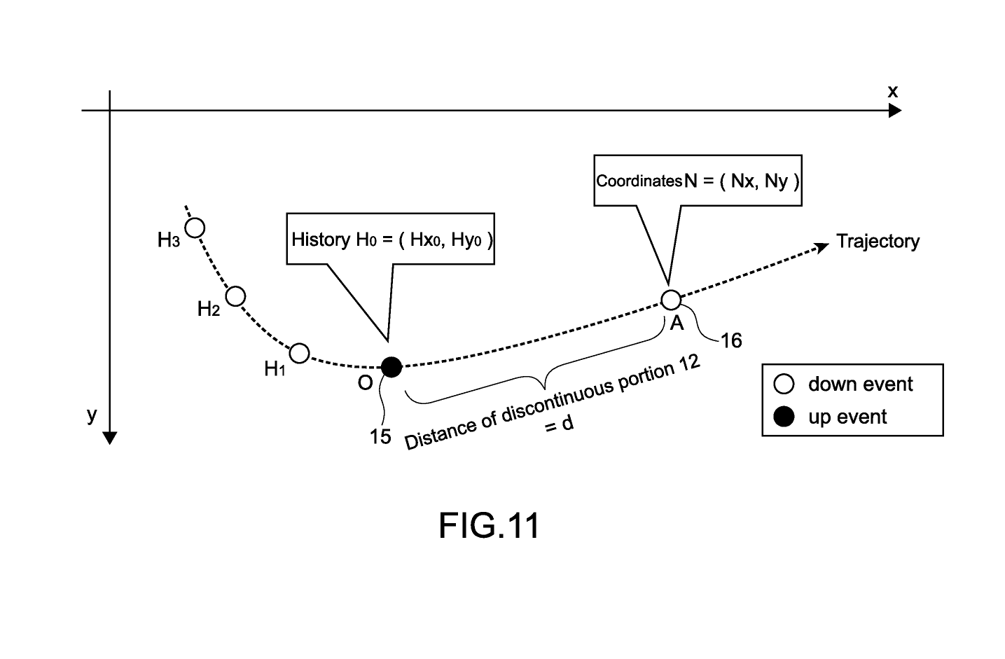

FIG. 11 is a view for explaining a determination based on the distance between the up-position and the down-position. As shown in the following formula, a distance d between the up-point O and the down-point A next to the up-point O is determined and compared with a threshold Distance.

d=\sqrt{(Nx−Hx₀)²+(Ny−Hy₀)²}<Distance [Math. 5]

If the distance d is larger than the threshold Distance, it is determined as not being continuous points and the filter is disabled. That is, it is determined as No in Step 110 of FIG. 7 and the up-event 15 is issued. If the distance d is smaller than the threshold Distance (Yes in Step 110), it is determined that the up-event 15 is invalid and the up-event 15 is discarded (Step 111). Then, the move event is continuously issued (Step 112). The above-mentioned determination based on the distance d between the two points is effective for, for example, distinguishing quick alternative continuous tap operations between two distant points by the multi-touch operation from the error detection of the up-event 15 due to low sensitivity.

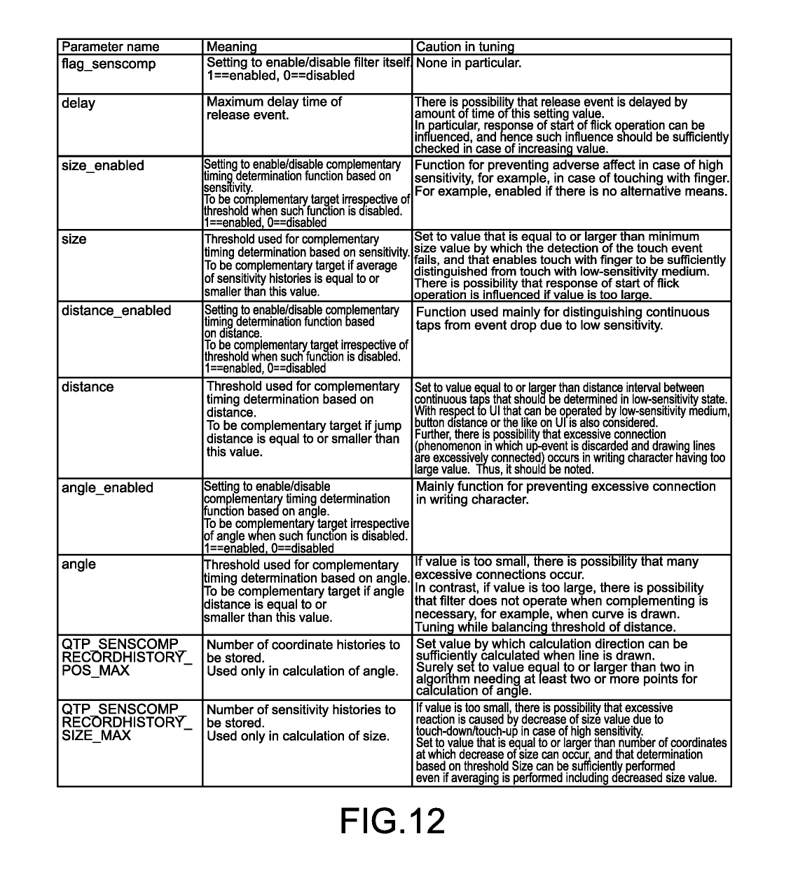

FIG. 12 is a table for explaining adjustment of parameters used for determining the validity of the up-event 15. When the validity of the up-event 15 is determined with the above-mentioned angle, time, sensitivity, and distance being parameters, there is a possibility that the following influences are caused. Thus, it is effective to appropriately perform tuning of the parameters.

(1) There is a possibility that a response of a determination of the flick operation is delayed.

(2) There is a possibility that it is difficult to perform continuous taps.

(3) There is a possibility that an excessive connection problem in which two move operations separately performed are considered as single one occurs.

In particular, in the case where the timer is set for a determination, the determination is waited until the timer fires, and hence the influence on the response of the determination of the flick operation described above is larger.

A parameter of “flag_senscomp” shown in FIG. 12 means a setting to enable or disable the filter itself for determining the up-event 15. The parameter becomes 1 in the case where the filter is enabled. The parameter becomes 0 in the case where the filter is disabled. There is no caution in tuning with respect to this parameter. Note that the parameter names shown in the table of FIG. 12 may be appropriately set.

“Delay” means a maximum delay time of a release event (up-event 16). This corresponds to a time until the timer fires. There is a possibility that the release event is delayed by an amount of time of this setting value. In particular, a response to the start of the flick operation is influenced, and hence it is necessary to sufficiently check the influence in the case of increasing the value. It is only necessary to determine an appropriate time for determining the validity of the up-event for the value of “delay,” for example, based on a refresh rate of the touch panel 107, the number of coordinates that recover an error, or the like.

“Size_enabled” means a setting to enable or disable a complementary timing determination function based on sensitivity of the touch operation. Here, the complementary timing corresponds to whether or not the filter is set. Thus, “size_enabled” means a setting of whether or not to use the sensitivity of the touch operation for this complementary timing (whether or not to set Step 102 of FIG. 7). In the case where the complementary timing determination function is enabled, the parameter becomes 1. In the case where the complementary timing determination function is disabled, the parameter becomes 0, and the filter is set and the validity is determined with respect to all the up-events 15 irrespective of the threshold of the sensitivity of the touch operation. This parameter can reduce a possibility that an influence is caused by the setting of the filter in the case of using the operation body having high sensitivity such as the finger. For example, a setting in which, if there is no alternative means, the complementary timing determination function is constantly enabled is conceivable.

“Size” is a threshold used for the determination in the case where the complementary timing determination function based on sensitivity is enabled. As also described above with reference to FIG. 8, for example, in the case where the average of sensitivity histories is equal to or smaller than this value, the filter is set and that touch operation becomes a complementary target. For example, a value that is equal to or larger than a minimum size by which the detection of the touch event fails, and that enables a touch with the finger to be sufficiently distinguished from a touch with the touch pen having low sensitivity is set. If the value is too large, there is a possibility that the response to the start of the flick operation is influenced. Therefore, this point should also be considered.

“Distance_enabled” means a setting to enable or disable the complementary timing determination function based on a distance. That is, the parameter indicating whether or not to use the distance between the two points for the complementary timing (whether or not to set Step 110 of FIG. 7) becomes “distance_enabled.” In the case where the complementary timing determination function based on a distance is enabled, the parameter becomes 1. In the case where the complementary timing determination function based on a distance is disabled, the parameter becomes 0, and the validity is determined with respect to the up-event 15 irrespective of a threshold of the distance.

“Distance” is a threshold used for the determination in the case where the complementary timing determination function based on a distance is enabled. In the case where the distance between the up-position and the down-position (jumping distance) is equal to or smaller than this value, the filter is set and that touch operation becomes a complementary target. For example, it is set to a value equal to or larger than the distance between continuous taps that should be distinguished in a low-sensitivity state. Further, a threshold value may be set considering also a distance between a plurality of buttons displayed in a user interface (UI). Further, if the value is large, in the case of drawing a character or the like, there is a possibility that an excessive connection (phenomenon in which the up-event 15 is discarded and drawing lines are excessively connected) is caused, which should be taken under consideration.

“Angle_enabled” means a setting to enable or disable the complementary timing determination function based on an angle. That is, the parameter indicating whether or not to use the displacement between the reference direction and the calculation direction for the complementary timing (whether or not to set Step 109 of FIG. 7) becomes “angle_enabled.” The parameter becomes 1 in the case where the complementary timing determination function based on an angle is enabled. The parameter becomes 0 in the case where the complementary timing determination function based on an angle is disabled, and the validity is determined with respect to the up-event 15. This parameter is effective for, for example, preventing an excessive connection in the case of writing a character.

“Angle” is a threshold used for the determination in the case where the complementary timing determination function based on a distance is enabled. If this value is too small, there is a possibility that many excessive connections occur. If the value is too large, there is a possibility that the filter does not operate in a situation in which complementing is necessary, for example, when a curve is drawn. For example, tuning is performed while balancing the threshold of “distance.”

“QTP_SENSCOMP_RECORDHISTORY_POS_MAX” is the number of coordinate histories stored in the storage unit 108. This is used for calculation of the displacement between the reference direction and the calculation direction. For example, this number is set such that the calculation direction when a line is drawn can be sufficiently calculated. Further, in the case where an algorithm that demands at least two points or more for calculating the reference direction is used, that value is surely set to two or more.

“QTP_SENSCOMP_RECORDHISTORY_SIZE_MAX” is the number of sensitivity histories stored in the storage unit 108. That is used for calculation of the sensitivity. If the value is too small, there is a possibility that an excessive reaction is caused by a decrease of the size value due to touch-down/touch-up in the case of the high sensitivity. It is set to a value that is equal to or larger than the number of coordinates at which the decrease of the size can occur, and that the determination based on the threshold Size can be sufficiently performed even if averaging is performed including the decreased size value.

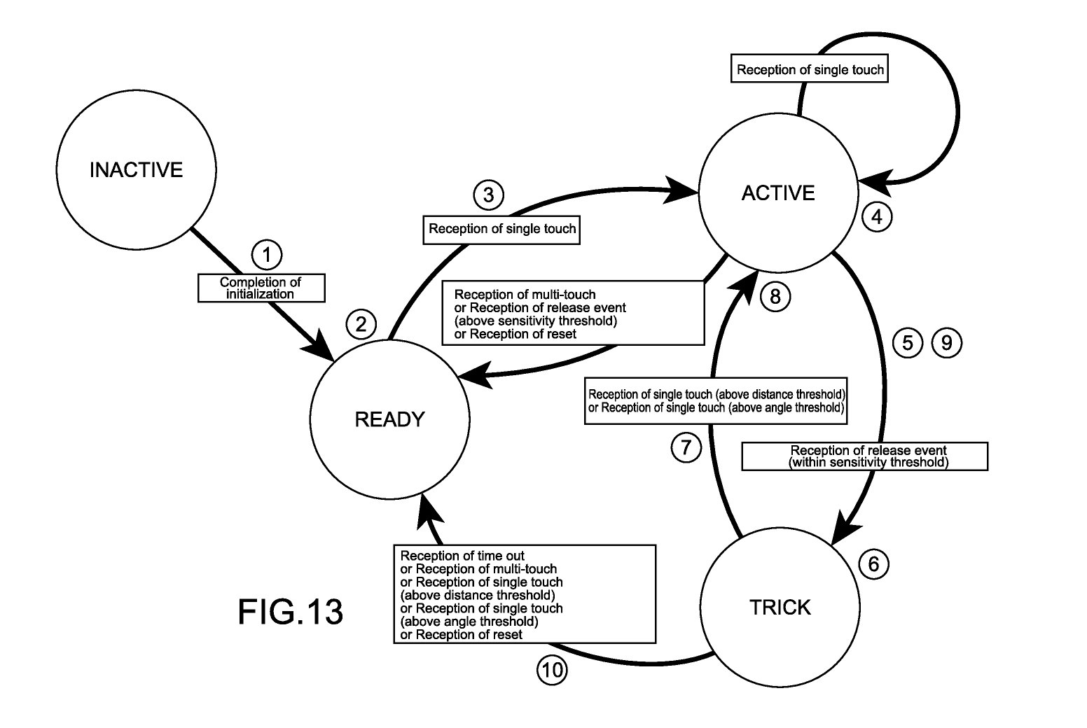

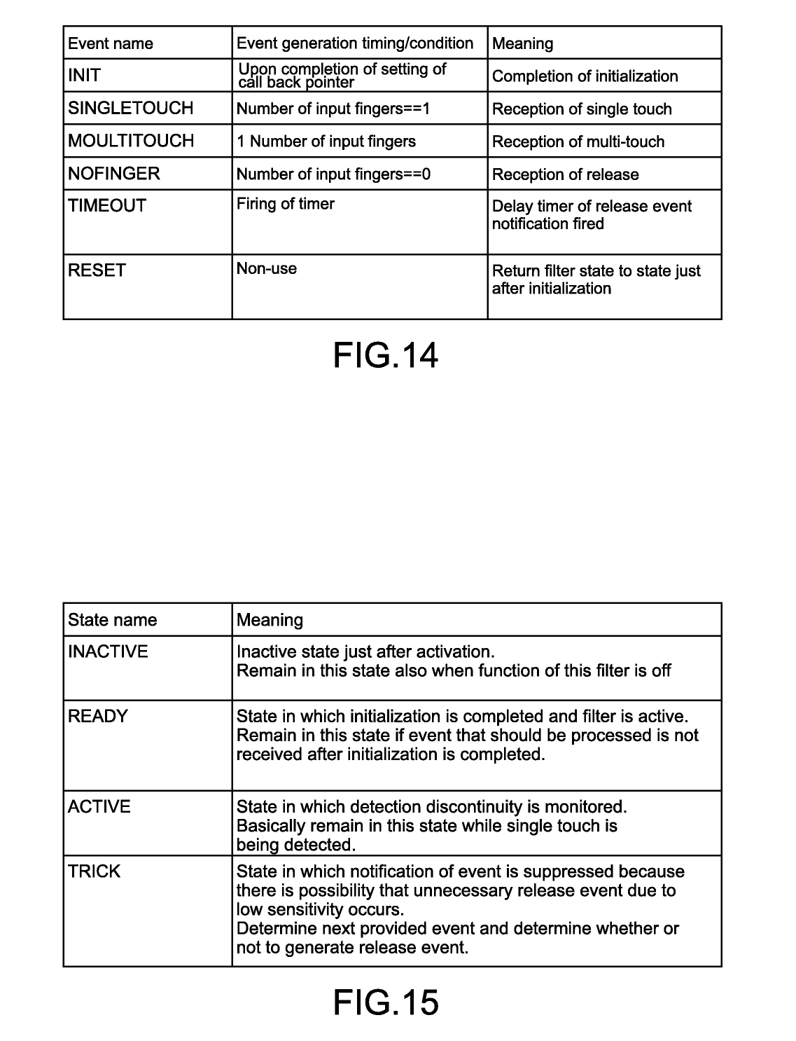

FIG. 13 is a state transition diagram showing an operation example of the tablet terminal 100 according to this embodiment. FIG. 14 is a view showing an example of an event defined in this embodiment. FIG. 15 is a view showing an example of a state defined in this embodiment.

For example, the operation information about the touch operation is determined and appropriately substituted by events “INIT,” “SINGLETOUCH,” “MOULTITOUCH,” “NOFINGER,” “TIMEOUT,” and “RESET” shown in FIG. 14. Further, it is assumed that four states “INACTIVE,” “READY,” “ACTIVE,” and “TRICK” shown in FIG. 15 are independently present and a transition other than in those internal events does not occur.

Transitions of the state as shown in FIG. 13 are performed. Among the transitions, transitions in the case where initialization is performed before the filter operates and it returns to a stand-by state are shown in the following:

(1) Completion of initialization of [INACTIVE]. Transition to READY.

(2) Start of drag according to user operation (start of move operation).

(3) Reception of single touch event of [READY]. Start of filter operation. Transition to ACTIVE.

(4) Generation of release event due to low sensitivity (user is performing drag).

(5) Reception of release event of [ACTIVE]. Start of timer and transition to TRICK. At this time, message that suppresses notification of release event to upper level is sent back to driver as call source (issue of up-event is delayed).

(6) Restoration from low sensitivity and generation of single touch.

(7) Reception of single touch of [TRICK]. Cancel of timer and transition to ACTIVE.

(8) Termination of user operation.

(9) Reception of release event of [ACTIVE]. Start of timer and transition to TRICK.

(10) Reception of time out of [TRICK]. Request driver side to issue release event to upper level and transition to READY state (issue of up-event).

As described above, in the tablet terminal 100 being the information processing apparatus according to this embodiment, the up-event 15 for detecting the up-operation and the down-event 16 for detecting the down-operation are input as the operation information for detecting the touch operation of the operation body on the operation surface 10. If the down-event 16 is input next to the up-event 15, whether or not the input up-event 15 is valid is determined based on the displacement amount between the reference direction with the up-point O being a reference and the calculation direction extending from the up-point O to the down-point A. For example, if the displacement amount is smaller than the predetermined value, there is a high possibility that the up-operation is not actually performed. Thus, in such a case, the up-event 15 is discarded. With this, it is possible to prevent error processing due to the error detection of the up-operation. It becomes possible to improve the operability of the touch operation on the operation surface 10. Further, if predetermined conditions regarding a time spacing, sensitivity, and a distance are satisfied, it becomes possible to realize the high operability adapted for the various touch operations by making a setting to determine the validity of the up-event 15.

Further, also under a situation in which it is difficult to stably detect a user operation, it becomes possible to prevent an error operation and to realize closer tracking of an actual operation. Further, in the case where the user operation can be stably detected, the filter is automatically disabled and it is possible to reduce the possibility that the operation is adversely affected. Further, the present disclosure is applicable irrespective of a system of the touch panel device. For example, it exerts a sufficient effect as counterforce against input with the touch pen in a capacitive system, input with a thin finger, a detection failure due to a lack of pressure in a pressure-sensitive system, a lack of detection in a hover system (also including use of gloves), and the like.

### Other Embodiments

The present disclosure is not limited to the above-mentioned embodiment and various other embodiments may be made.

In the above-mentioned embodiment, as shown in FIG. 10, whether or not the first operation information is valid is determined based on the displacement amount between the reference direction with the up-position being a reference and the calculation direction calculated as a direction extending from the up-position to the down-position. With this, generation of an excessive connection problem in the case of writing a character or the like with the touch pen is prevented.

The present disclosure is not limited to this method, and the determination of the validity of the first operation information based on the movement of the operation body may be performed by another method. That is, the validity of the input first operation information may be determined based on a change amount in the movement direction on the operation surface at the up-position or a position with the up-position being a reference. For example, a change amount between the movement direction of the operation body up to the up-position or the position with the up-position being a reference and the movement direction of the operation body after passing through the up-position or the position with the up-position being a reference is calculated. If the change amount is smaller than the predetermined value, it may be determined that input first operation information is not valid. Note that the position with the up-position being a reference is, for example, a position or the like within an area near the up-position. In addition to this, the position with the up-position being a reference may include a position (coordinate point) used for calculating the change amount in the movement direction of the operation body. Hereinafter, the up-position and the position with the up-position being a reference will be referred to as an up-position or the like.

A calculation method for the change amount in the movement direction at the up-position or the like is not limited, and an arbitrary technique may be used. For example, a curve passing through the up-position or the like may be approximately calculated and the change amount in the movement direction may be calculated based on a curvature at the up-position or the like. As a calculation method for an approximate curve, a calculation method for a spline curve, or the like may be appropriately used. Alternatively, the change amount in the movement direction may be calculated without using the information on the down-position. Still alternatively, the movement of the operation body may be detected by another sensor apparatus including a camera and the like and the change amount in the movement direction may be calculated based on a result thereof. By calculating the change amount in the movement direction in this manner, it becomes possible to prevent the above-mentioned excessive connection problem.

Note that, in the above-mentioned embodiment, the change amount in the movement direction on the operation surface of the operation body is defined based on the displacement amount between the reference direction with the up-position being a reference and the calculation direction calculated as a direction extending from the up-position to the down-position. That is, as one method of determining the change amount in the movement direction, the determination of the displacement amount between the reference direction and the calculation direction is employed. With this, it becomes possible to determine the change amount in the movement direction by a simple arithmetic operation.

In the above, the validity of the first operation information is determined when the second operation information is input next to the input of the first operation information. However, irrespective of whether or not the second operation information is next input, the validity of the first operation information may be determined. For example, in the case of not using the information on the down-position, such processing is performed. With this, it is possible to improve the processing speed of the determination processing. On the other hand, if reliability is determined when the second operation information is next input, it becomes possible to reduce the total arithmetic processing amount.

In the flowchart shown in FIG. 7, determinations based on the parameters are performed in the following order:

(1) Determination of sensitivity of touch operation

(2) Timer determination after up-event detection

(3) Determination of displacement amount (angle) of direction

(4) Determination of distance

In particular, assuming that (3) determination of angle is performed, the embodiment has been described by adding the determinations based on the other parameters to (3) determination of angle. However, the technique for improving the operability of the touch operation is not limited to the technique assuming that (3) is performed.

For example, the validity of the up-event may be determined by any one or an arbitrary combination of (1) to (4) above. For example, with (2) timer determination being a reference, the validity of the up-event may be determined by any one or a combination of other (1), (3), and (4) when the down-event is detected in the predetermined period of time for the timer determination. Selection of the parameters is optional and may be appropriately set depending on the kind of application, the kind of a touch operation to be input, and the like. Further, the setting may be automatically performed.

In the case where (2) timer determination is a reference, although also described above, there is a possibility that the flick operation or the like is influenced. For the purpose of reducing the influence, (1), (3), and (4) may be appropriately set as additions.

Providing setting items in the UI displayed on the display screen of the touch panel or the like, ON/OFF and the like of the functions of the parameters may be selectable by the user. With this, it is possible to give a use feeling suitable for each user. Further, utilizing a mechanism of turning ON/OFF the functions for each application and each UI, it is also possible to set the filter that determines the validity of the up-event in only a particular scene.

In the above, the determination of the validity is performed depending on the time, the sensitivity, the distance, and the angle of the trajectory. In addition, other elements may be used as parameters for determining the validity. With this, it becomes possible to perform a more precise determination. For example, elements by which an operation actually input can be estimated, such as handwriting, an operation habit, and a position of a UI component, may be used as parameters.

An application range of the present disclosure is not limited to a touch sensor device such as the touch panel. For example, in a pointing device using a camera, the same effects are obtained by calculating the number of nodes (sensitivity: size) defined by this algorithm based on information on a pixel or the like. Further, in the case where a pointing device is provided to be connected to a network, the same effects are obtained by applying the present disclosure with a communication state or the like being used as the number of nodes.

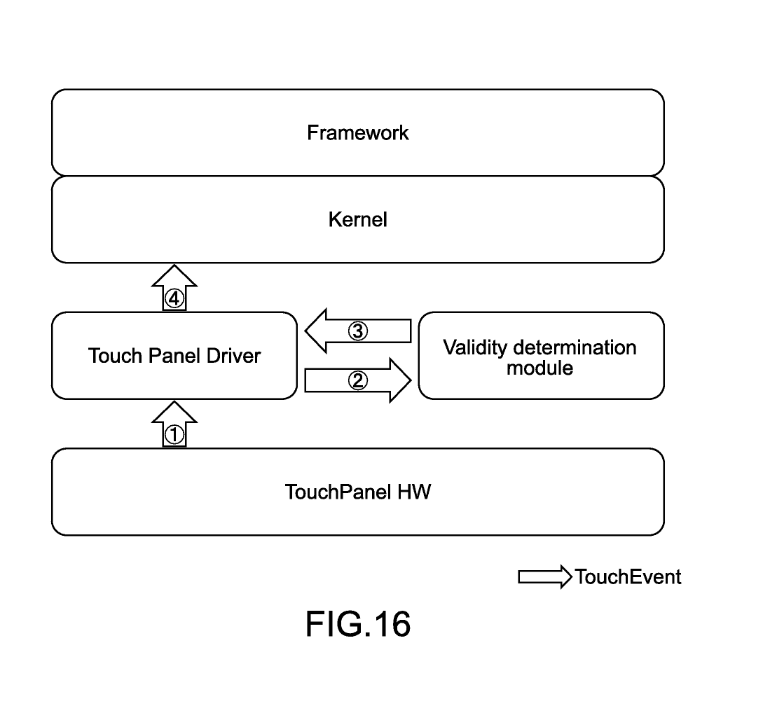

FIG. 16 is a block diagram showing an implementation example of a module that executes a determination of the validity according to an embodiment of the present disclosure. The performance of the touch panel device is promoted year by year and the accuracy thereof reaches a significantly high level. On the other hand, there are more severe user's needs, various environment causes, and the like, and hence it cannot be said that a necessary and sufficient performance is constantly provided in all use cases. In order to meet such needs at a current time point, it is necessary to compensate for the limited performance of the device. A validity determination module according to this embodiment can be realized as a filter group prepared for meeting the severe needs in a software manner.

As shown in FIG. 16, the validity determination module can be implemented in a state being sandwiched between a series of data flows of HW→Driver→Kernel of the touch panel event. With this, the present disclosure can be carried out without largely changing the flow from HW to Kernel. Before notifying kernel of the touch event (1) received from the HW module, Touch Panel Driver passes (2) the touch event through the validity determination module and can obtain a corrected result and complementary information (3). After that, Touch Panel Driver performs a determination and the like of the complementary information and notifies Kernel of the event data after the correction depending on needs (4). Such implementation is possible. However, an implementing layer is not limited. It may be implemented in a driver layer of the touch panel or can be implemented in any layer from device firmware to an application layer.

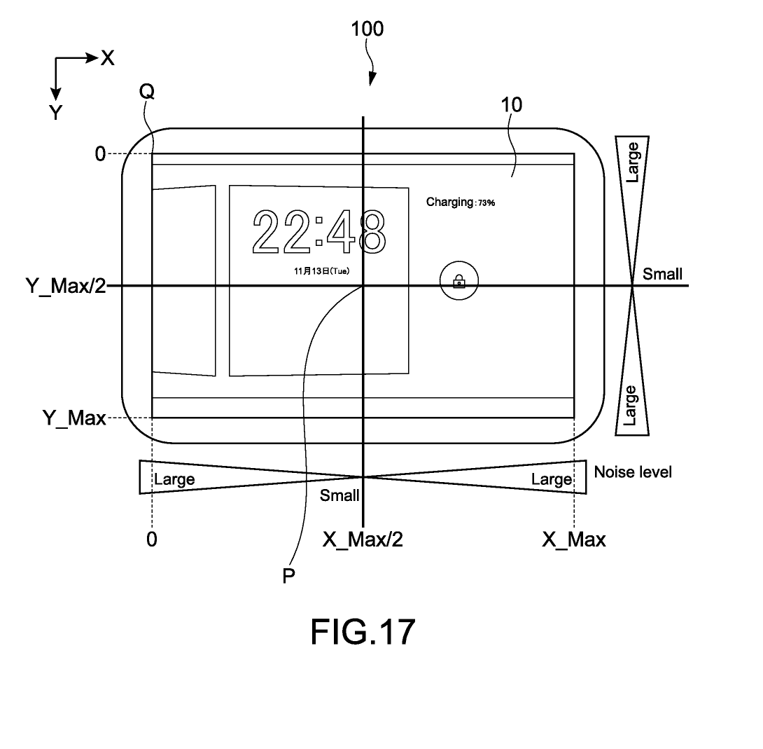

The parameter for determining the validity of the up-event may be dynamically changed depending on situations. FIG. 17 is a view showing a dynamic modified example. As shown in FIG. 17, with an upper left point of the operation surface 10 being a reference point Q, a coordinate system is set with an x-coordinate component ranging from 0 to X_Max and a y-coordinate component ranging from 0 to Y_Max. When viewed with (X_Max/2, Y_Max/2) being a screen center P, the noise is smallest at the screen center P and increases in noise level while going a screen end. By dynamically changing the threshold Distance of the distance and the threshold Angle of the angle corresponding to this, it becomes possible to enable the filter more effectively. For example, it is assumed that the touch area moves from a center P to the end of the screen and the noise level is (small→large). Correspondingly, the threshold Distance is dynamically changed from (small→large) and the threshold Angle is dynamically changed from (large→small). With this, it becomes possible to realize high operability. Further, the operability may be improved by turning On/Off this algorithm only in a handwriting input area or the like.

As a technique related to the present disclosure, a strain correction technique to be described in the following may be used. For example, this strain correction may be additionally set as the filter.

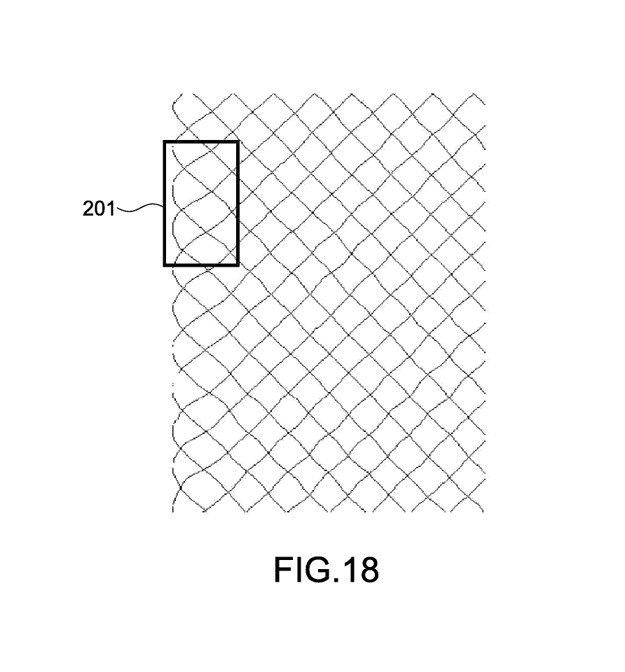

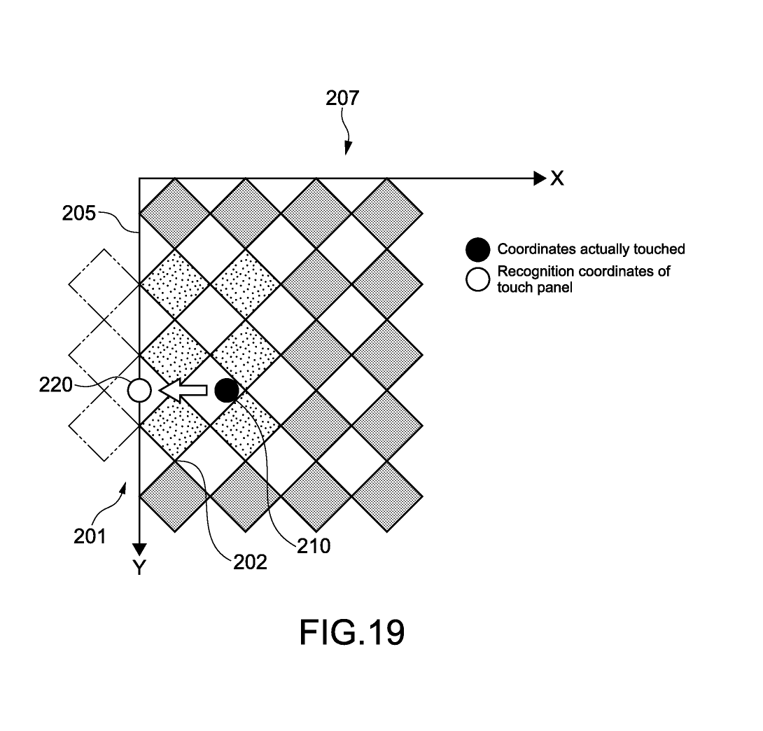

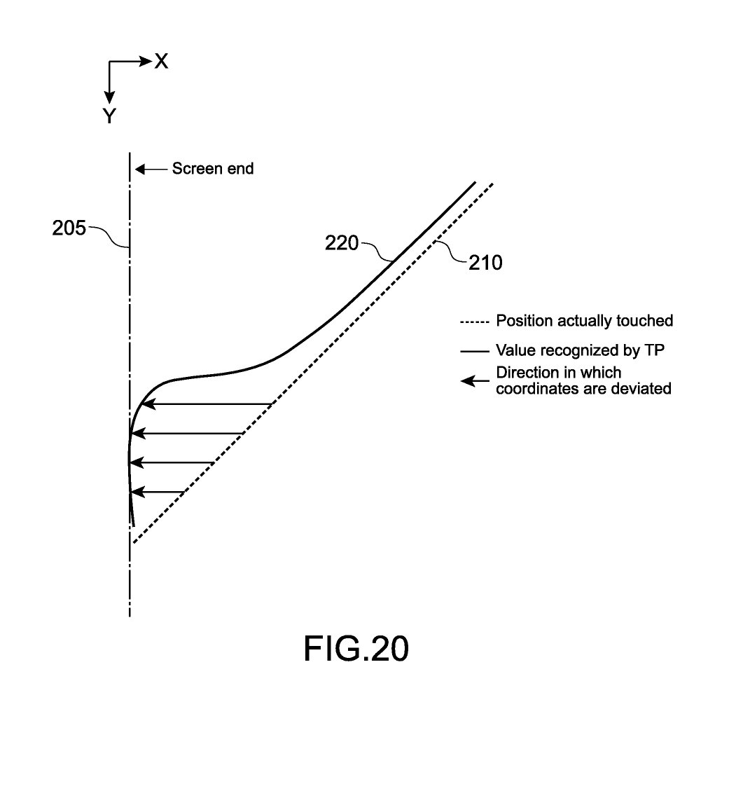

FIGS. 18 to 20 are views for explaining an outline of the strain correction technique. In a device with a capacitance-type touch panel, a problem in that a coordinate accuracy is significantly lowered at a screen end portion 201 of a liquid crystal display (LCD) often occurs. Such a problem may lead to a large deterioration of the usability. For example, it may be difficult to operate a graphical user interface (GUI) at the screen end portion 201. As a cause of this problem, as shown in FIG. 19, the absence of a sensor 202 at the end portion 201 is exemplified. Specifically, in a capacitance-type touch panel 207, a coordinate value is calculated generally based on sensor values around a contact point 210. However, at the screen end portion 201, the sensor 202 (situated at intersection of grid line in figure) is not present outside the screen, and hence the accuracy of the coordinate detection is sufficiently obtained. As a result, as shown in FIGS. 19 and 20, it is recognized that coordinates of a recognition point 220 recognized by the touch panel 207 are deviated from coordinates of the actual contact point 210 in a direction to be attracted to a screen end 205. In a strain correction technique described here, a correction aimed to model a pattern of a strain (deviation of coordinate) for each device type and increase a linearity at the screen end portion 201 is performed.

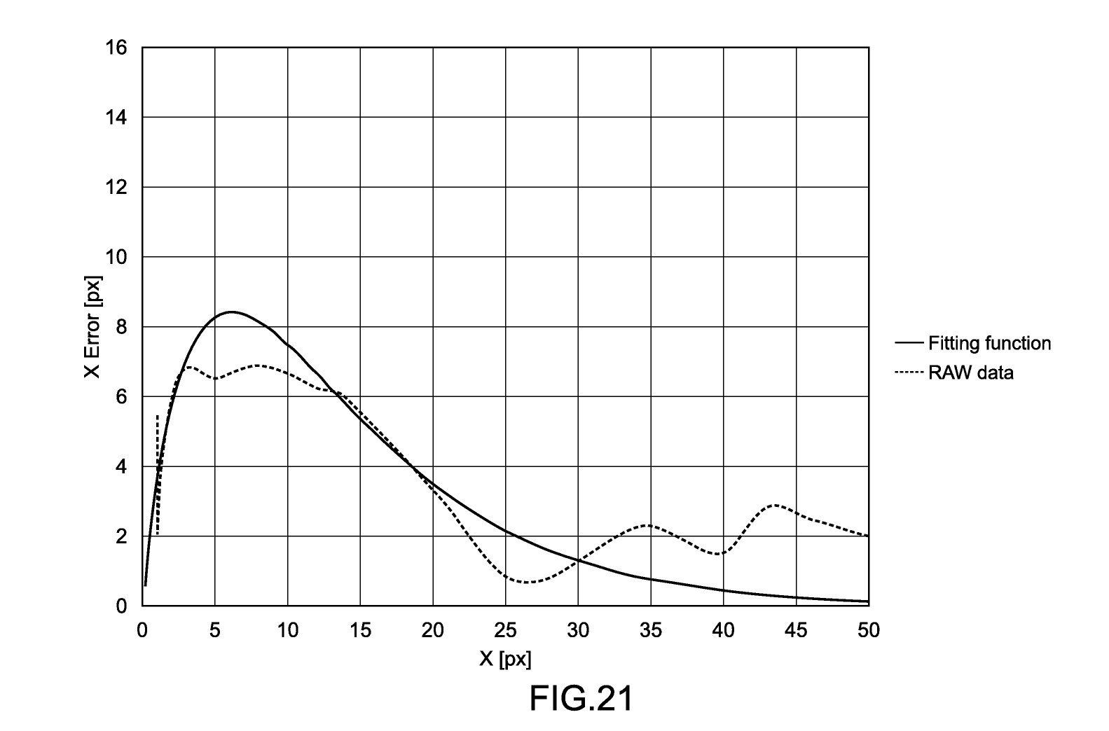

FIGS. 21 to 23 are views for explaining details of a strain correction technique. Assuming that a main cause of lowering of the linearity at the screen end portion 201 is a lack of reference point deficiency (lack of sensor) for calculating the coordinate value, as shown also in FIGS. 19 and 20, it is considered that a deviation occurs mainly in an X-direction at a position at which the sensor value in a Y-direction is sufficiently referred to. In an actual device, when the screen is divided into four areas in a Y-axis direction and a deviation amount between the actual contact point 210 and the recognition point 210 in each area is calculated, it is confirmed that the deviation amount is large at the screen end portion 201 in the X-direction and a degree of deviation barely depends on a position in the Y-axis direction. Thus, a strain correction filter can independently perform a correction in the X-direction and the Y-direction.

An example of a correction algorithm of a strain correction filter will be described in detail. First, the deviation amount from a true value at the screen end portion 201 can be expressed by f(d) with respect to the distance d (≧0) from a screen end 205 in each axial direction. Here, f(d) is expressed as fΘ(d) as a parametric non-linear fitting function defined by a plurality of parameters Θ. For example, fΘ(d) is expressed by the following formula using a logarithm.

$${f}_{Θ} ( d ) = - {Ad}^{B} \frac{log ( \frac{d}{C} )}{exp ( \frac{d}{D} )} + E \\ Θ = ( A , B , C , D , E ) \qquad [ Math . 6 ]$$

Using this function fΘ(d), the deviation amount from a true value with respect to the distance d from the screen end 205 when the value of Θ is adjusted is approximated as shown in FIG. 21. The vertical axis of FIG. 21 indicates an x-coordinate and the horizontal axis indicates a deviation of coordinate in the x-axis direction. Various methods are assumed with respect to the design of a parameter array Θ. Here, employed is an approach in which formulation is performed as a minimization problem with a deviation amount between a coordinate (≈ true value) accurately plotted by an industrial robot and a coordinate received from the touch panel being as an evaluation value and a suboptimal solution is determined by a general search method. Other methods may be used. Using the approximated deviation amount as a correction amount of the coordinate value, a value p recognized by the touch panel is corrected in a direction away from the screen end 205 as shown in the following formula. Here, p0 is a coordinate of the screen end 205 closest to the coordinate point p and p′ is a coordinate after the correction.

$${p}^{’} = p + {f}_{Θ} ( d ) \frac{p - {p}_{0}}{\vert p - {p}_{0} \vert} \qquad [ Math . 7 ]$$

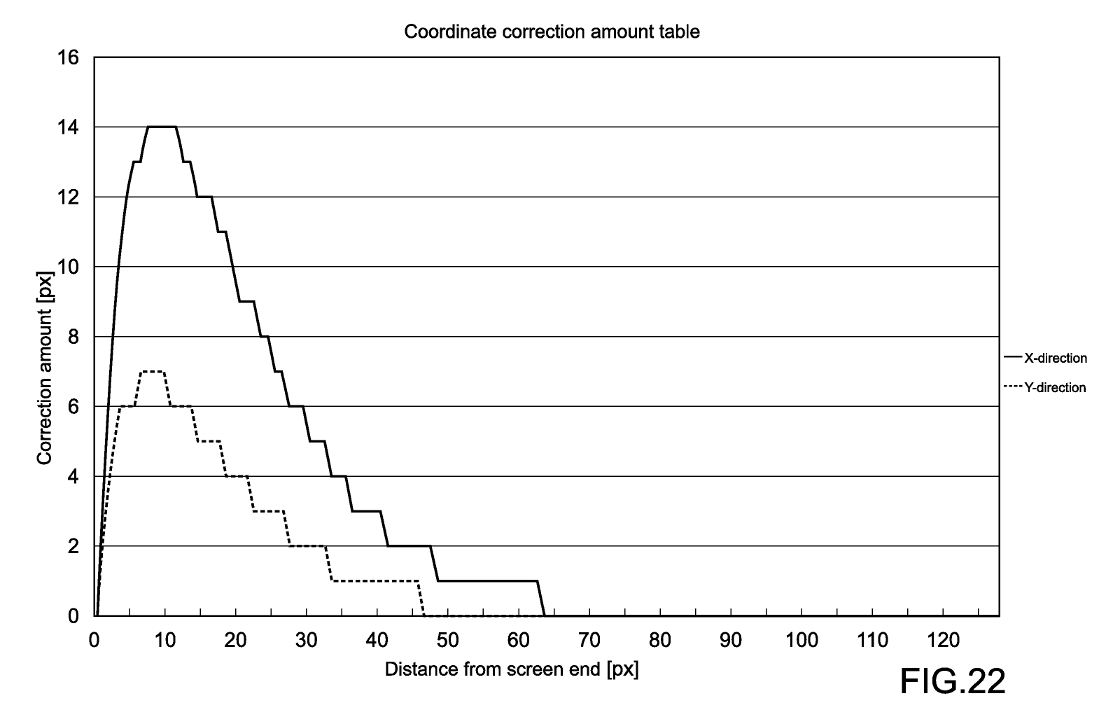

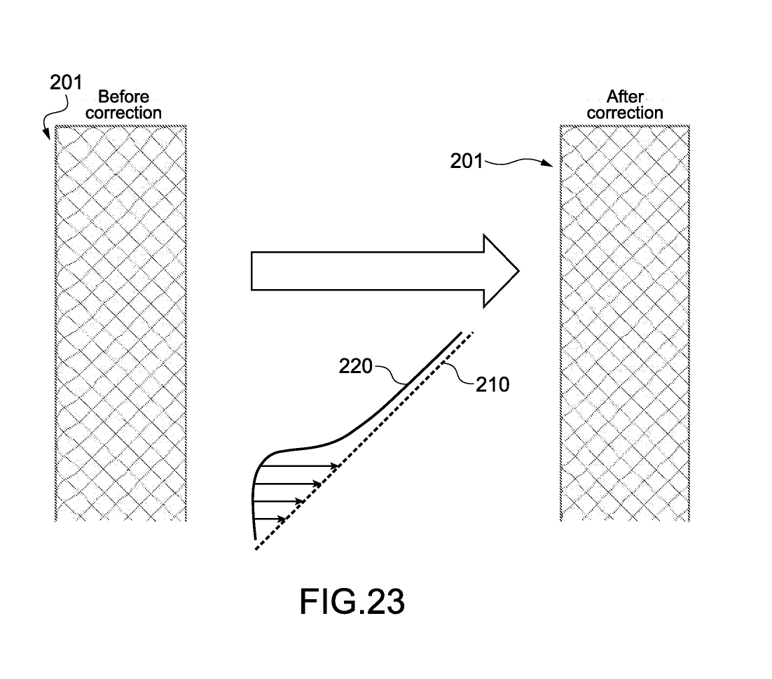

When the strain correction filter is actually implemented within the driver, it is often difficult to implement fΘ(d) as a continuous function using a mathematical function. In view of this, as shown in FIG. 22, the following processing is also effective. Specifically, in this processing, fΘ(d) is converted into a table with respect to the X- and Y-directions at the same time as the design of Θ, and a correction amount depending on a position is calculated from the table upon actual use or the like. By such an algorithm, as shown in FIG. 23, it is possible to correct the strain of the screen end portion 201 by approximating the coordinate of the recognition point 210 to the actual coordinate of the contact point 210.

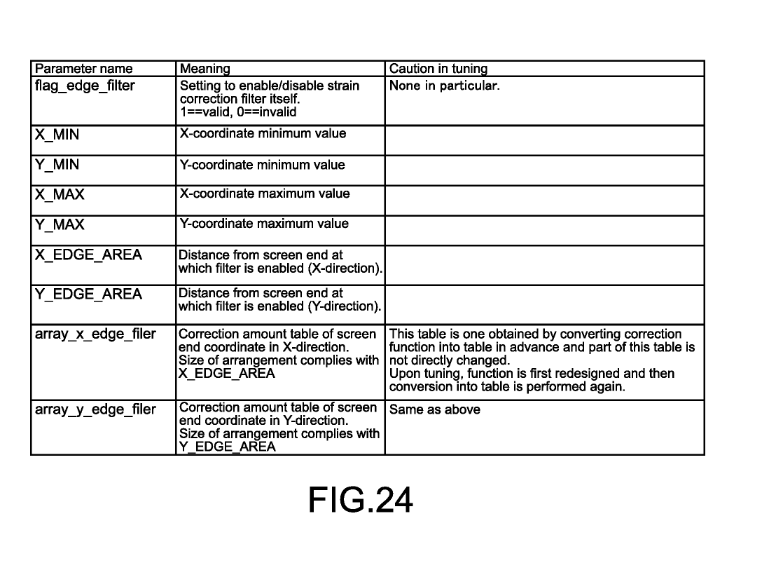

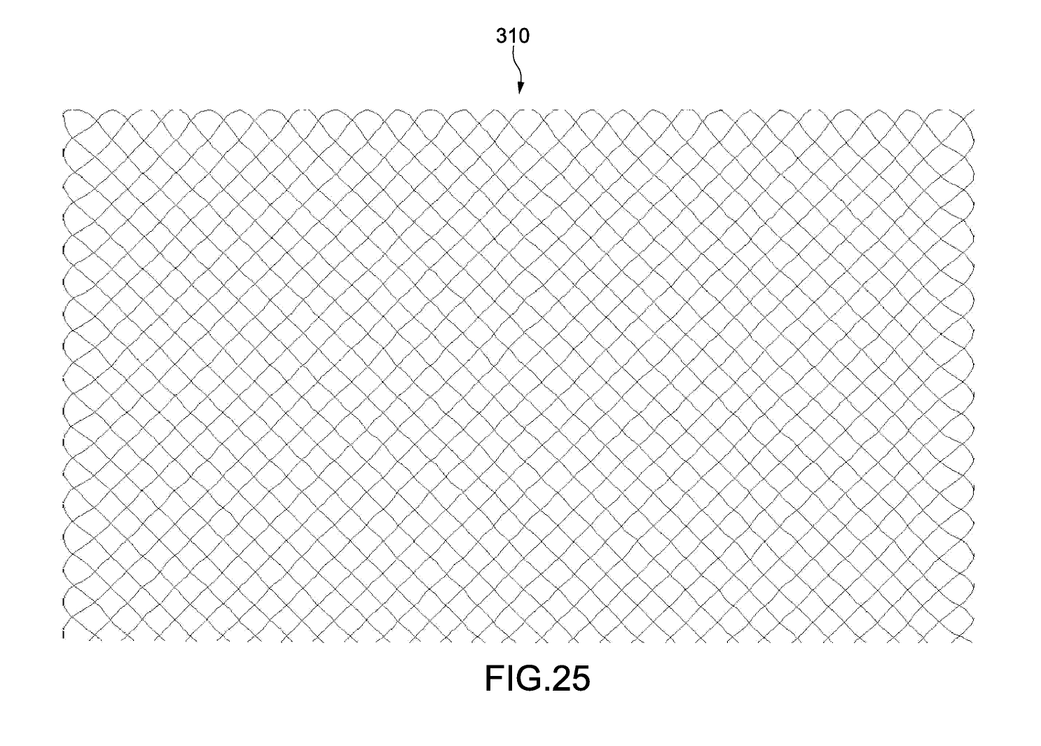

FIG. 24 is a table for explaining tuning of a parameter used in the strain correction filter. By performing tuning suitable for a target device with respect to each parameter, it is possible to obtain excellent effects. In FIG. 24, each correction amount table of “array_x_edge_filter” and “array_y_edge_filter” is one obtained by converting a correction function into a table in advance, and typically, part of this table is not directly changed. Upon tuning, the function is redesigned and then conversion into a table is performed again. However, the present disclosure is not limited thereto.

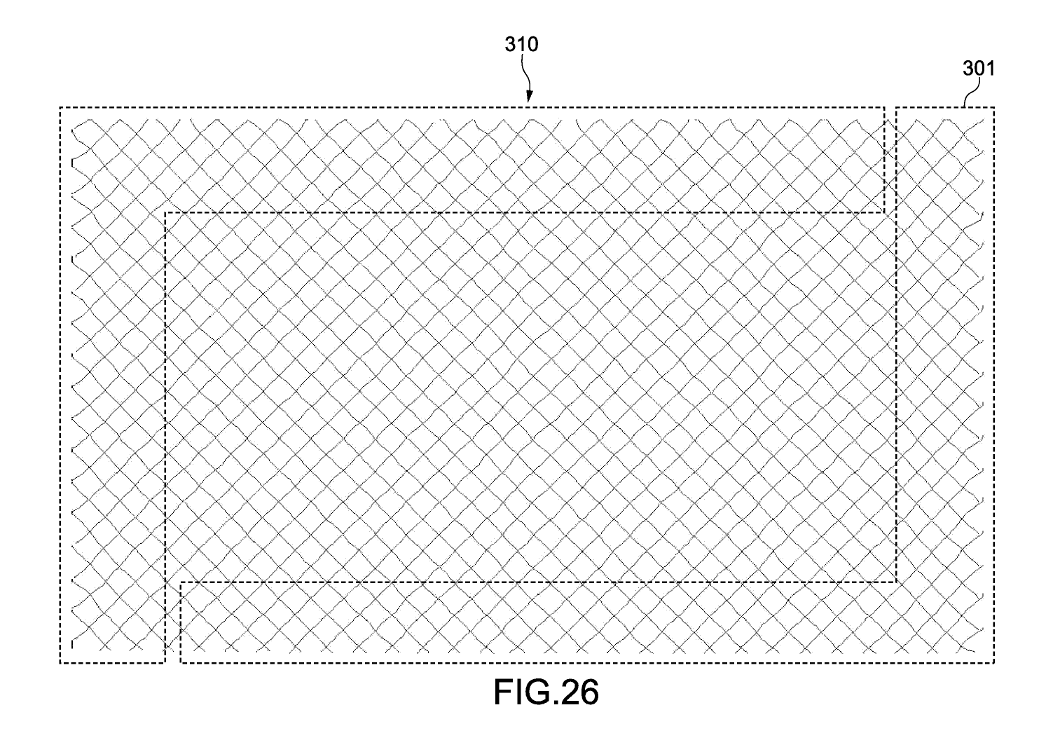

FIGS. 25 and 26 are views for observing the effects of the strain correction filter in an entire operation surface 310. FIG. 25 is a view before the correction and FIG. 26 is a view after the correction. In an entire area of a screen end portion 301 of FIG. 26, it can be seen that the coordinate value is suitably corrected. Note that, by modeling a pattern of a strain (deviation of coordinate), it is also possible to perform the correction of the coordinate value in an entire area of the operation surface 310. For example, it is possible to perform such a correction by appropriately setting the fitting function.

Among the features of the above-mentioned embodiment, it is also possible to combine at least two features.

Note that the present disclosure may also take the following configurations:

(1) An information processing apparatus, including:

an input unit configured to be capable of inputting, as operation information for detecting an operation on an operation surface of an operation body, first operation information for detecting an up-operation from the operation surface, the first operation information including information on an up-position as information on a position at which the up-operation is performed; and

a control unit configured to determine whether or not the input first operation information is valid based on a change amount in a movement direction on the operation surface of the operation body at a position with the up-position being a reference.

(2) The information processing apparatus according to (1), in which

the control unit is configured to determine that the input first operation information is not valid when the change amount in the movement direction on the operation surface of the operation body is smaller than a predetermined value.

(3) The information processing apparatus according to (1) or (2), in which

the input unit is configured to be capable of inputting second operation information for detecting a down-operation on the operation surface, the second operation information including information on a down-position as information on a position at which the down-operation is performed, and

the control unit is configured to perform the determination when the second operation information for detecting the down-operation is input next to input of the first operation information.

(4) The information processing apparatus according to (3), in which

the control unit is configured to define, based on a displacement amount between a reference direction calculated with the up-position being a reference and a calculation direction calculated as a direction extending from the up-position to the down-position next to the up-position, the change amount in the movement direction on the operation surface of the operation body.

(5) The information processing apparatus according to (3) or (4), in which

the control unit is configured to perform the determination when the input of the second operation information is performed within a predetermined period of time from input of the first operation information.

(6) The information processing apparatus according to any one of (3) to (5), in which

the control unit is configured to perform the determination when sensitivity of a touch operation including at least the up-operation and the down-operation is smaller than a predetermined value.

(7) The information processing apparatus according to any one of (3) to (6), in which

the control unit is configured to perform the determination when a distance between the up-position and the down-position is smaller than a predetermined value.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
an input unit configured to be capable of inputting, as operation information for detecting an operation on an operation surface of an operation body, first operation information for detecting an up-operation from the operation surface, the first operation information including information on an up-position as information on a position at which the up-operation is performed; and
a control unit configured to determine whether or not the input first operation information is valid based on a change amount in a movement direction on the operation surface of the operation body at a position with the up-position being a reference.

2. The information processing apparatus according to claim 1, wherein
the control unit is configured to determine that the input first operation information is not valid when the change amount in the movement direction on the operation surface of the operation body is smaller than a predetermined value.

3. The information processing apparatus according to claim 1, wherein
the input unit is configured to be capable of inputting second operation information for detecting a down-operation on the operation surface, the second operation information including information on a down-position as information on a position at which the down-operation is performed, and
the control unit is configured to perform the determination when the second operation information for detecting the down-operation is input next to input of the first operation information.

4. The information processing apparatus according to claim 3, wherein
the control unit is configured to define, based on a displacement amount between a reference direction calculated with the up-position being a reference and a calculation direction calculated as a direction extending from the up-position to the down-position next to the up-position, the change amount in the movement direction on the operation surface of the operation body.

5. The information processing apparatus according to claim 3, wherein
the control unit is configured to perform the determination when the input of the second operation information is performed within a predetermined period of time from input of the first operation information.

6. The information processing apparatus according to claim 3, wherein
the control unit is configured to perform the determination when sensitivity of a touch operation including at least the up-operation and the down-operation is smaller than a predetermined value.

7. The information processing apparatus according to claim 3, wherein
the control unit is configured to perform the determination when a distance between the up-position and the down-position is smaller than a predetermined value.

8. An information processing method, comprising: by a computer,
inputting, as operation information for detecting an operation on an operation surface of an operation body, first operation information for detecting an up-operation from the operation surface, the first operation information including information on an up-position as information on a position at which the up-operation is performed; and
determining whether or not the input first operation information is valid based on a change amount in a movement direction on the operation surface of the operation body at a position with the up-position being a reference.

9. A program that causes a computer to execute the steps of:
inputting, as operation information for detecting an operation on an operation surface of an operation body, first operation information for detecting an up-operation from the operation surface, the first operation information including information on an up-position as information on a position at which the up-operation is performed; and
determining whether or not the input first operation information is valid based on a change amount in a movement direction on the operation surface of the operation body at a position with the up-position being a reference.
